(19) United States
(12) Patent Application Publication
(10) Pub. No.: US 2016/0307368 A1
(43) Pub. Date: Oct. 20, 2016

(54) COMPRESSION AND INTERACTIVE PLAYBACK OF LIGHT FIELD PICTURES

(71) Applicant: Lytro, Inc., Mountain View, CA (US)

(72) Inventors: Kurt Akeley, Saratoga, CA (US); Nikhil Karnad, Mountain View, CA (US); Keith Leonard, Moon Township, PA (US); Colvin Pitts, Snohomish, WA (US)

(21) Appl. No.: 15/097,152

(22) Filed: Apr. 12, 2016

Related U.S. Application Data
(60) Provisional application No. 62/148,917, filed on Apr. 17, 2015.

(51) Int. Cl. G06T 17/20; G06T 1/60; H04N 13/00; G06T 15/04; G06T 15/40; G06T 3/00; G06T 15/20; G06T 1/00

(52) U.S. Cl. CPC G06T 17/20; G06T 15/205; G06T 1/60; G06T 1/0007; G06T 15/04; G06T 15/405; G06T 3/0093; H04N 13/0048; G06T 2210/36; G06T 2210/32

(57) ABSTRACT

A compressed format provides more efficient storage for light-field pictures. A specialized player is configured to project virtual views from the compressed format. According to various embodiments, the compressed format and player are designed so that implementations using readily available computing equipment are able to project new virtual views from the compressed data at rates suitable for interactivity. Virtual-camera parameters, including but not limited to focus distance, depth of field, and center of perspective, may be varied arbitrarily within the range supported by the light-field picture, with each virtual view expressing the parameter values specified at its computation time. In at least one embodiment, compressed light-field pictures containing multiple light-field images may be projected to a single virtual view, also at interactive or near-interactive rates. In addition, virtual-camera parameters beyond the capability of a traditional camera, such as “focus spread”, may also be varied at interactive rates.

### CROSS-REFERENCE TO RELATED APPLICATIONS

The present application claims priority from U.S. Provisional Application Ser. No. 62/148,917, for “Compression and Interactive Playback of Light-field Images” (Atty. Docket No. LYT191-PROV), filed Apr. 17, 2015, the disclosure of which is incorporated herein by reference.

The present application is related to U.S. Utility application Ser. No. 14/311,592, for “Generating Dolly Zoom Effect Using Light-field Image Data” (Atty. Docket No. LYT003-CONT), filed Jun. 23, 2014 and issued on Mar. 3, 2015 as U.S. Pat. No. 8,971,625, the disclosure of which is incorporated herein by reference.

The present application is related to U.S. Utility application Ser. No. 13/774,971 for “Compensating for Variation in Microlens Position during Light-Field Image Processing,” (Atty. Docket No. LYT021), filed Feb. 22, 2013 and issued on Sep. 9, 2014 as U.S. Pat. No. 8,831,377, the disclosure of which is incorporated herein by reference.

### FIELD

The present application relates to compression and interactive playback of light-field images.

### BACKGROUND

Light-field pictures and images represent an advancement over traditional two-dimensional digital images because light-field pictures typically encode additional data for each pixel related to the trajectory of light rays incident to that pixel sensor when the light-field image was taken. This data can be used to manipulate the light-field picture through the use of a wide variety of rendering techniques that are not possible to perform with a conventional photograph. In some implementations, a light-field picture may be refocused and/or altered to simulate a change in the center of perspective (CoP) of the camera that received the picture. Further, a light-field picture may be used to generate an extended depth-of-field (EDOF) image in which all parts of the image are in focus. Other effects may also be possible with light-field image data.

Light-field pictures take up large amounts of storage space, and projecting their light-field images to (2D) virtual views is computationally intensive. For example, light-field pictures captured by a typical light-field camera, such as the Lytro ILLUM camera, can include 50 Mbytes of light-field image data; processing one such picture to a virtual view can require tens of seconds on a conventional personal computer.

It is therefore desirable to define an intermediate format for these pictures that consumes less storage space, and may be projected to virtual views more quickly. In one approach, stacks of virtual views can be computed and stored. For example, a focus stack may include five to fifteen 2D virtual views at different focus distances. The focus stack allows a suitable player to vary focus distance smoothly at interactive rates, by selecting at each step the two virtual views with focus distances nearest to the desired distance, and interpolating pixel values between these images. While this is a satisfactory solution for interactively varying focus distance, the focus stack and focus-stack player cannot generally be used to vary other virtual-camera parameters interactively. Thus, they provide a solution specific to refocusing, but they do not support generalized interactive playback.

In principle, a multi-dimensional stack of virtual views with arbitrary dimension, representing arbitrary virtual-camera parameters, can be pre-computed, stored, and played back interactively. In practice, this is practical for at most two or three dimensions, meaning for two or at most three interactive virtual-camera parameters. Beyond this limit, the number of virtual views that must be computed and stored becomes too great, requiring both too much time to compute and too much space to store.

### SUMMARY

The present document describes a compressed format for light-field pictures, and further describes a player that can project virtual views from the compressed format. According to various embodiments, the compressed format and player are designed so that implementations using readily available computing equipment (e.g., personal computers with graphics processing units) are able to project new virtual views from the compressed data at rates suitable for interactivity (such as 10 to 60 times per second, in at least one embodiment). Virtual-camera parameters, including but not limited to focus distance, depth of field, and center of perspective, may be varied arbitrarily within the range supported by the light-field picture, with each virtual view expressing the parameter values specified at its computation time. In at least one embodiment, compressed light-field pictures containing multiple light-field images may be projected to a single virtual view, also at interactive or near-interactive rates. In addition, virtual-camera parameters beyond the capability of a traditional camera, such as “focus spread”, may also be varied at interactive rates.

### BRIEF DESCRIPTION OF THE DRAWINGS

The accompanying drawings illustrate several embodiments and, together with the description, serve to explain various principles according to the embodiments. One skilled in the art will recognize that the particular embodiments illustrated in the drawings are merely exemplary, and are not intended to limit scope.

FIG. 1 is a flow diagram depicting a sequence of operations performed by graphics hardware according to one embodiment.

FIG. 2 is a flow diagram depicting a player rendering loop, including steps for processing and rendering multiple compressed light-field images, according to one embodiment.

FIG. 3 depicts two examples of stochastic patterns with 64 sample locations each.

FIG. 4 depicts an example of occlusion processing according to one embodiment.

FIGS. 5A and 5B depict examples of a volume of confusion representing image data to be considered in applying blur for a pixel, according to one embodiment.

FIG. 6 depicts a portion of a light-field image.

FIG. 7 depicts an example of an architecture for implementing the methods of the present disclosure in a light-field capture device, according to one embodiment.

FIG. 8 depicts an example of an architecture for implementing the methods of the present disclosure in a player device communicatively coupled to a light-field capture device, according to one embodiment.

FIG. 9 depicts an example of an architecture for a light-field camera for implementing the methods of the present disclosure according to one embodiment.

FIG. 10 is a flow diagram depicting a method for determining a pattern radius, according to one embodiment.

### DETAILED DESCRIPTION

### Definitions

For purposes of the description provided herein, the following definitions are used. These definitions are provided for illustrative and descriptive purposes only, and are not intended to limit the scope of the description provided herein.
Aperture stop (or aperture): The element, be it the rim of a lens or a separate diaphragm, that determines the amount of light reaching the image.
B. The factor that, when multiplied by the difference of a lambda depth from the focal plane lambda depth, yields the radius of the circle of confusion. B is inversely related to the virtual-camera depth of field.
Blur view. A virtual view in which each pixel includes a stitch factor, in addition to a color.
Bokeh. The character and quality of blur in an image, especially a virtual view.
Bucket spread. The range of sample-pixel lambda depths for which samples are accumulated into a bucket.
Center of perspective (CoP). The 3D point in space from which a virtual view is correctly viewed.
Conventional image. An image in which the pixel values are not, collectively or individually, indicative of the angle of incidence at which light is received on the surface of the sensor.
Depth. A representation of distance between an object and/or corresponding image sample the entrance pupil of the optics of the capture system.
Center view. A virtual view with a large depth of field, and a symmetric field of view. (A line extended from the CoP through the center of the image is perpendicular to the image plane.) An EDOF view, projected from light-field data with its CoP at the center of the entrance pupil, is an example of a center view.
Circle of confusion (CoC). A slice of the volume of confusion at a specific lambda depth.
Color. A short vector of color-components that describes both chrominance and luminance.
Color component. A single value in a color (vector), indicating intensity, in the range [0,1], for a range of spectral colors. Color components are understood to be linear representations of luminance. In at least one embodiment, if nonlinear representations are employed (e.g., to improve storage efficiency), then they are linearized prior to any arithmetic use.
Decimated image. An image that has been decimated, such that its pixel dimensions are lower than their original values, and its pixel values are functions (e.g., averages or other weighted sums) of the related pixels in the original image.
Depth of field. The range of object distances for which a virtual view is sufficiently sharp.
Depth map. A two-dimensional array of depth values, which may be calculated from a light-field image.
Disk. A region in a light-field image that is illuminated by light passing through a single microlens; may be circular or any other suitable shape.
Entrance pupil (EP). The apparent location of the aperture stop of an objective lens, viewed from a point well ahead of the camera along the optical axis. Only light that passed through the EP enters the camera, so the EP of a light-field camera is the virtual surface on which the light-field is captured.
Extended depth-of-field view (EDOF view). A virtual view with the maximum possible depth of field. More generally, any virtual view with a large depth of field.
Extent. A circular or square region in an image, which is centered at a pixel.
Extent radius. The radius (or half edge length) of the circular (or square) extent.
Focus spread. A reshaping of the relationship of image blur to object distance from focal plane, in which a range of object distances around the focal plane are sharp, and distances beyond this range have blur in proportion to their distance beyond the sharp range.
Fragment Shader. An application-specified algorithm or software component that is applied to each fragment rasterized in a graphics pipeline.
Frame buffer. The texture that is modified by rasterized fragments under the control of the Raster Operations. The frame buffer may also contain a z-buffer.
Full-resolution image. An image that has not been decimated. Its pixel dimensions are unchanged.
Hull view. A virtual view whose focus distance matches that of the corresponding center view, and whose focal plane is coplanar with the focal plane of the corresponding center view, but whose CoP is transversely displaced from the center-view CoP, by an amount known as the relative CoP (RCoP). A hull view is further related to the corresponding center view in that scene objects at the shared focus distance also share (x,y) image coordinates. Thus, the hull view is a sheared projection of the scene.
Image. A 2D array of values, often including color values.
Input device. Any device that receives input from a user.
Lambda depth. Depth relative to the image plane of the camera: positive toward the objective lens, negative away from the objective lens. In a plenoptic light-field camera, the units of lambda depth may be related to the distance between the plane of the micro-lens array and the plane of the image sensor.
Plenoptic light-field camera. A light-field camera with a micro-lens array directly ahead of the photosensor. An example of such a camera is provided by Lytro, Inc. of Mountain View, California.
Light-field camera. A device capable of capturing a light-field image.
Light-field data. Data indicative of the angle of incidence at which light is received on the surface of the sensor.
Light-field image. An image that contains a representation of light-field data captured at the sensor, which may be a four-dimensional sample representing information carried by ray bundles received by a single light-field camera. Each ray is indexed by a standard 4D coordinate system.
Light-field picture. One or more light-field images, each with accompanying metadata. A light-field picture may also include the compressed representation of its light-field images.
Main lens, or “objective lens”. A lens or set of lenses that directs light from a scene toward an image sensor.
Mesh. A collection of abutting triangles (or other shapes) that define a tessellated surface in 3D coordinates. For example, each triangle vertex can include a position tuple with x, y, and z coordinates, and may also include other parameters. The position tuples are shared at shared vertexes (so that the mesh surface is continuous), but other vertex parameters may not be shared (so they may be discontinuous at the edges of triangles).
Mesh view. A virtual view in which each pixel includes a depth value, in addition to the color value.
Microlens. A small lens, typically one in an array of similar microlenses.
Microlens array. An array of microlenses arranged in a predetermined pattern.
Objective lens. The main lens of a camera, especially of a plenoptic light-field camera.
Photosensor. A planar array of light-sensitive pixels.
Player. An implementation of the techniques described herein, which accepts a compressed light-field and a set of virtual-camera parameters as input, and generates a sequence of corresponding virtual views.
Plenoptic light-field camera. A type of light-field camera that employs a microlens-based approach in which a plenoptic microlens array is positioned between the objective lens and the photosensor.
Plenoptic microlens array. A microlens array in a plenoptic camera that is used to capture directional information for incoming light rays, with each microlens creating an image of the aperture stop of the objective lens on the surface of the image sensor.
Processor: any processing device capable of processing digital data, which may be a microprocessor, ASIC, FPGA, or other type of processing device.
Project, projection. The use of a virtual camera to create a virtual view from a light-field picture.
Rasterization. The process of forming vertexes into triangles, determining which pixels in the frame buffer have their centers within each triangle, and generating a fragment for each such pixel, which fragment includes an interpolation of each parameter attached to the vertexes.
Ray bundle, ray, or bundle. A set of light rays recorded in aggregate by a single pixel in a photosensor.
Reduction. Computing a single value that is a function of a large number of values. For example, a minimum reduction may compute a single minimum value from tens or hundreds of inputs. Also, the value that results from a reduction.
Reduction image. An image wherein each pixel is a reduction of values in the corresponding extent of the source image.
Relative center of perspective. (RCoP) The 2D coordinate expressing the transverse (x,y plane) displacement of the CoP of a hull view relative to the CoP of the corresponding center view.
Saturated color. A weighted color whose weight is 1.0.
Sensor, photosensor, or image sensor. A light detector in a camera capable of generating images based on light received by the sensor.
Stitch factor. A per-pixel scalar value that specifies the behavior of

Stitched Interpolation.
Texture. An image that is associated with a graphics pipeline, such that it may either be accessed by a Fragment Shader, or rendered into as part of the Frame Buffer.
Vertex Shader. An application-specified algorithm or software application that is applied to each vertex in a graphics pipeline.
Virtual camera. A mathematical simulation of the optics and image formation of a traditional camera, whose parameters (e.g., focus distance, depth of field) specify the properties of the player's output image (the virtual view).
Virtual view. The 2D image created from a light-field picture by a virtual camera. Virtual view types include, but are not limited to, refocused images and extended depth of field (EDOF) images.
Volume of Confusion (VoC). A pair of cones, meeting tip-to-tip at a point on the virtual-camera focal plane, whose axes of rotation are collinear and are perpendicular to planes of constant lambda depth, and whose radii increase linearly with lambda depth from the focal plane, at a rate B which is determined by the virtual-camera depth of field. Larger depths of field correspond to smaller values of B.
Weight. A continuous factor that indicates a fraction of the whole. For example, a weight of ¼ indicates ¼ of the whole. Although weights may be conveniently thought to have a range of [0,1], with one corresponding to the notion of all-of-the-whole, weights greater than one have mathematical meaning.
Weighted color. A tuple consisting of a weight and a color that has been scaled by that weight. Each component of the color is scaled.
Z-buffer. An representation of depth values that is optionally included in the Frame Buffer.

In addition, for ease of nomenclature, the term “camera” is used herein to refer to an image capture device or other data acquisition device. Such a data acquisition device can be any device or system for acquiring, recording, measuring, estimating, determining, and/or computing data representative of a scene, including but not limited to two-dimensional image data, three-dimensional image data, and/or light-field data. Such a data acquisition device may include optics, sensors, and image processing electronics for acquiring data representative of a scene, using techniques that are well known in the art. One skilled in the art will recognize that many types of data acquisition devices can be used in connection with the present disclosure, and that the disclosure is not limited to cameras. Thus, the use of the term “camera” herein is intended to be illustrative and exemplary, but should not be considered to limit the scope of the disclosure. Specifically, any use of such term herein should be considered to refer to any suitable device for acquiring image data.

In the following description, several techniques and methods for processing, storing, and rendering light-field pictures are described. One skilled in the art will recognize that these various techniques and methods can be performed singly and/or in any suitable combination with one another. Further, many of the configurations and techniques described herein are applicable to conventional imaging as well as light-field imaging. Thus, although the following description focuses on light-field imaging, many of the following systems and methods may additionally or alternatively be used in connection with conventional digital imaging systems.

### Architecture

In at least one embodiment, the system and method described herein can be implemented in connection with light-field images captured by light-field capture devices including but not limited to those described in Ng et al., Light-field photography with a hand-held plenoptic capture device, Technical Report CSTR 2005-02, Stanford Computer Science. More particularly, the techniques described herein can be implemented in a player that accepts a compressed light-field and a set of virtual-camera parameters as input, and generates a sequence of corresponding virtual views.

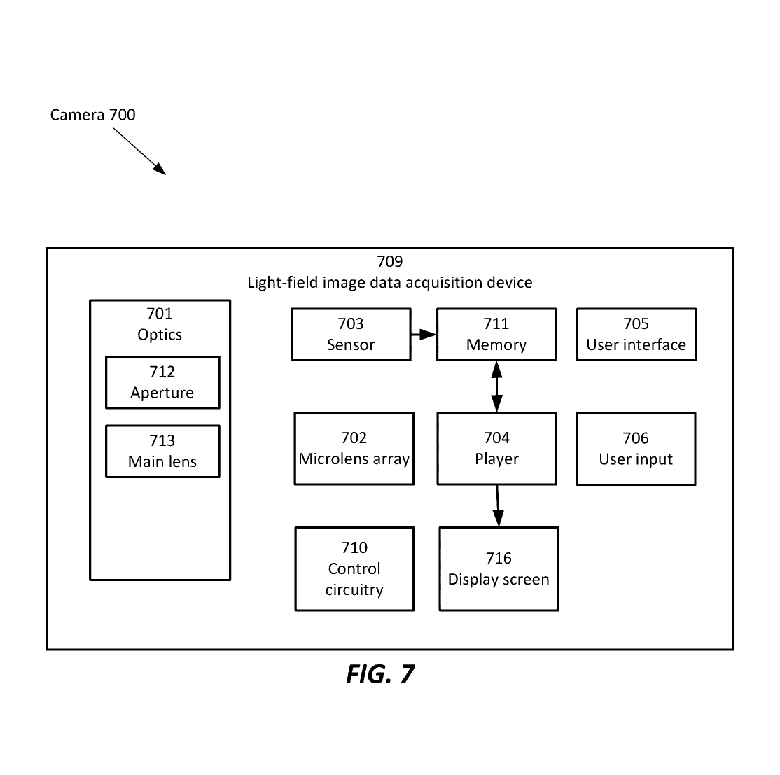

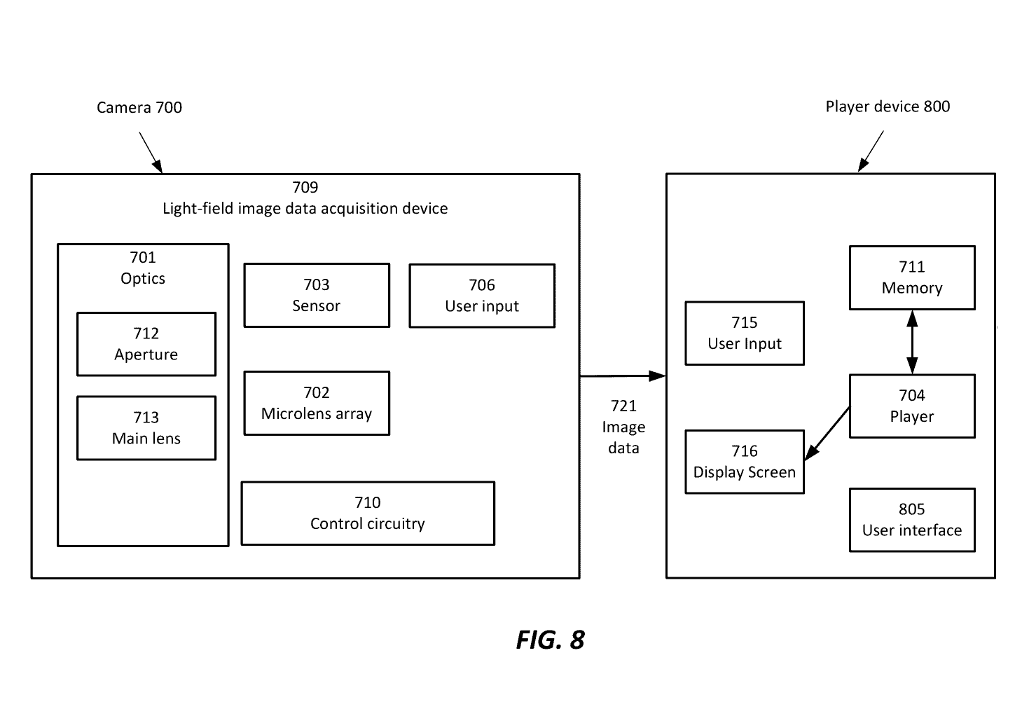

The player can be part of a camera or other light-field acquisition device, or it can be implemented as a separate component. Referring now to FIG. 7, there is shown a block diagram depicting an architecture wherein player 704 is implemented as part of a light-field capture device such as a camera 700. Referring now also to FIG. 8, there is shown a block diagram depicting an architecture wherein player 704 is implemented as part of a stand-alone player device 800, which may be a personal computer, smartphone, tablet, laptop, kiosk, mobile device, personal digital assistant, gaming device, wearable device, or any other type of suitable electronic device. In at least one embodiment, the electronic device may including graphics accelerators (GPUs) to facilitate fast processing and rendering of graphics data. Player device 800 is shown as communicatively coupled to a light-field capture device such as a camera 700; however, in other embodiments, player device 800 can be implemented independently without such connection. One skilled in the art will recognize that the particular configurations shown in FIGS. 7 and 8 are merely exemplary, and that other architectures are possible for camera 700. One skilled in the art will further recognize that several of the components shown in the configurations of FIGS. 7 and 8 are optional, and may be omitted or reconfigured.

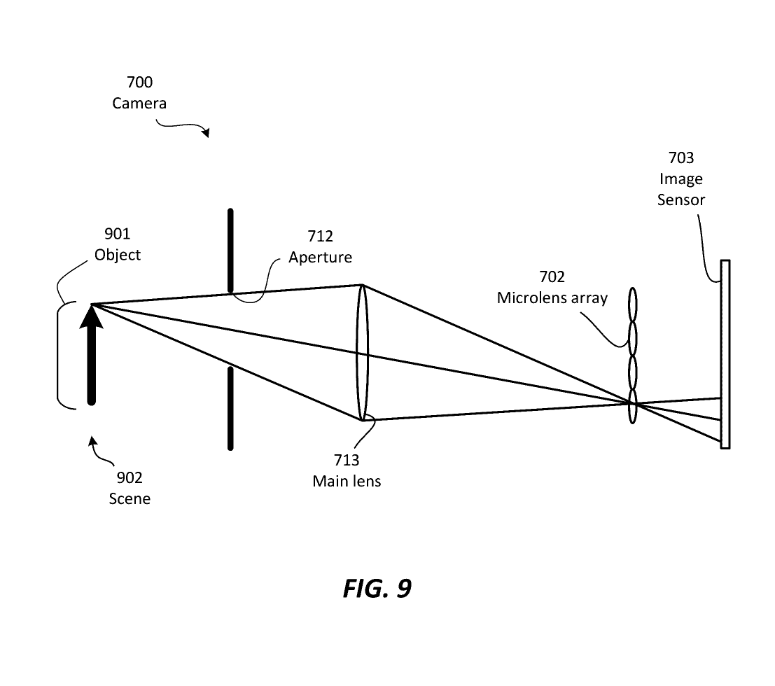

In at least one embodiment, camera 700 may be a light-field camera that includes light-field image data acquisition device 709 having optics 701, image sensor 703 (including a plurality of individual sensors for capturing pixels), and microlens array 702. Optics 701 may include, for example, aperture 712 for allowing a selectable amount of light into camera 700, and main lens 713 for focusing light toward microlens array 702. In at least one embodiment, microlens array 702 may be disposed and/or incorporated in the optical path of camera 700 (between main lens 713 and image sensor 703) so as to facilitate acquisition, capture, sampling of, recording, and/or obtaining light-field image data via image sensor 703. Referring now also to FIG. 9, there is shown an example of an architecture for a light-field camera, or camera 700, for implementing the method of the present disclosure according to one embodiment. The Fig. is not shown to scale. FIG. 9 shows, in conceptual form, the relationship between aperture 712, main lens 713, microlens array 702, and image sensor 703, as such components interact to capture light-field data for one or more objects, represented by an object 901, which may be part of a scene 902.

In at least one embodiment, camera 700 may also include a user interface 705 for allowing a user to provide input for controlling the operation of camera 700 for capturing, acquiring, storing, and/or processing image data, and/or for controlling the operation of player 704. User interface 705 may receive user input from the user via an input device 706, which may include any one or more user input mechanisms known in the art. For example, input device 706 may include one or more buttons, switches, touch screens, gesture interpretation devices, pointing devices, and/or the like.

Similarly, in at least one embodiment, player device 800 may include a user interface 805 that allows the user to control operation of device 800, including the operation of player 704, based on input provided via user input device 715.

In at least one embodiment, camera 700 may also include control circuitry 710 for facilitating acquisition, sampling, recording, and/or obtaining light-field image data. For example, control circuitry 710 may manage and/or control (automatically or in response to user input) the acquisition timing, rate of acquisition, sampling, capturing, recording, and/or obtaining of light-field image data.

In at least one embodiment, camera 700 may include memory 711 for storing image data, such as output by image sensor 703. Such memory 711 can include external and/or internal memory. In at least one embodiment, memory 711 can be provided at a separate device and/or location from camera 700.

In at least one embodiment, captured light-field image data is provided to player 704, which renders the compressed light-field image data at interactive rates for display on display screen 716. Player 704 may be implemented as part of light-field image data acquisition device 709, as shown in FIG. 7, or it may be part of a stand-alone player device 800, as shown in FIG. 8. Player device 800 may be local or remote with respect to light-field image data acquisition device 709. Any suitable wired or wireless protocol can be used for transmitting image data 721 to player device 800; for example, camera 700 can transmit image data 721 and/or other data via the Internet, a cellular data network, a Wi-Fi network, a Bluetooth communication protocol, and/or any other suitable means. Alternatively, player device 800 can retrieve image data 721 (including light-field image data) from a storage device or any other suitable component.

### Overview

Light-field images often include a plurality of projections (which may be circular or of other shapes) of aperture 712 of camera 700, each projection taken from a different vantage point on the camera's focal plane. The light-field image may be captured on image sensor 703. The interposition of microlens array 702 between main lens 713 and image sensor 703 causes images of aperture 712 to be formed on image sensor 703, each microlens in microlens array 702 projecting a small image of main-lens aperture 712 onto image sensor 703. These aperture-shaped projections are referred to herein as disks, although they need not be circular in shape. The term “disk” is not intended to be limited to a circular region, but can refer to a region of any shape.

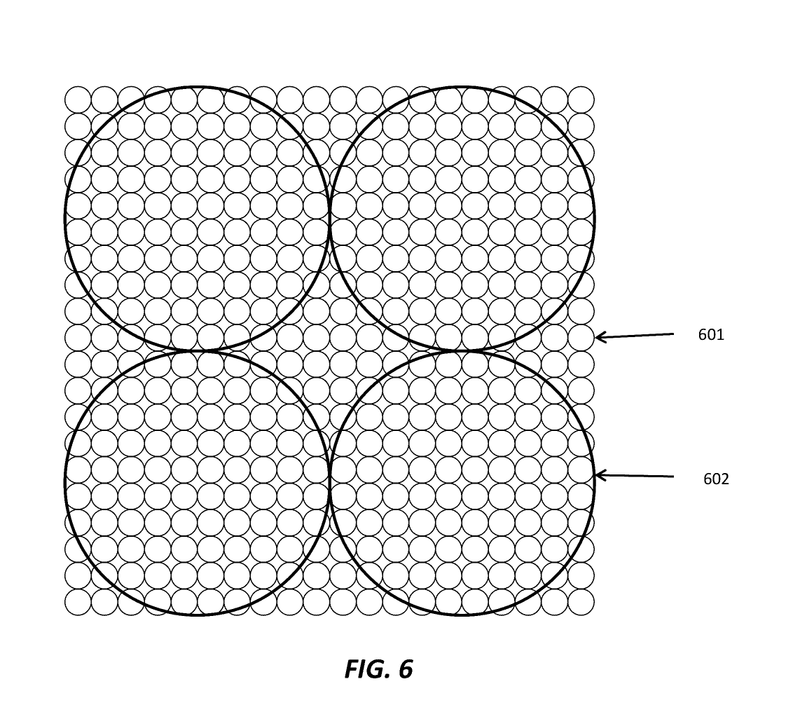

Light-field images include four dimensions of information describing light rays impinging on the focal plane of camera 700 (or other capture device). Two spatial dimensions (herein referred to as x and y) are represented by the disks themselves. For example, the spatial resolution of a light-field image with 120,000 disks, arranged in a Cartesian pattern 400 wide and 300 high, is 400×300. Two angular dimensions (herein referred to as u and v) are represented as the pixels within an individual disk. For example, the angular resolution of a light-field image with 100 pixels within each disk, arranged as a 10×10 Cartesian pattern, is 10×10. This light-field image has a 4-D (x,y,u,v) resolution of (400,300,10,10). Referring now to FIG. 6, there is shown an example of a 2-disk by 2-disk portion of such a light-field image, including depictions of disks 602 and individual pixels 601; for illustrative purposes, each disk 602 is ten pixels 601 across.

In at least one embodiment, the 4-D light-field representation may be reduced to a 2-D image through a process of projection and reconstruction. As described in more detail in related U.S. Utility application Ser. No. 13/774,971 for “Compensating for Variation in Microlens Position during Light-Field Image Processing,” (Atty. Docket No. LYT021), filed Feb. 22, 2013 and issued on Sep. 9, 2014 as U.S. Pat. No. 8,831,377, the disclosure of which is incorporated herein by reference, a virtual surface of projection may be introduced, and the intersections of representative rays with the virtual surface can be computed. The color of each representative ray may be taken to be equal to the color of its corresponding pixel.

### Useful Concepts

### Weighted Color

It is often useful to compute a color that is a linear combination of other colors, with each source color potentially contributing in different proportion to the result. The term Weight is used herein to denote such a proportion, which is typically specified in the continuous range [0,1], with zero indicating no contribution, and one indicating complete contribution. But weights greater than one are mathematically meaningful.

A Weighted Color is a tuple consisting of a weight and a color whose components have all been scaled by that weight.

A_{w}=[Aw_{A},w_{A}]=[c_{A},w_{A}]

The sum of two or more weighted colors is the weighted color, whose color components are each the sum of the corresponding source color components, and whose weight is the sum of the source weights.

A_{w}+B_{w}=[c_{A}+c_{B},w_{A}+w_{B}]

A weighted color may be converted back to a color by dividing each color component by the weight. (Care must be taken to avoid division by zero.)

$$A = \frac{{c}_{A}}{{w}_{A}}$$

When a weighted color that is the sum of two or more source weighted colors is converted back to a color, the result is a color that depends on each source color in proportion to its weight.

A weighted color is saturated if its weight is one. It is sometimes useful to limit the ordered summation of a sequence of weighted colors such that no change is made to the sum after it becomes saturated. Sum-to-saturation(A_{w},B_{w}) is defined as the sum of A_{w} and B_{w} if the sum of w_{A} and w_{B} is not greater than one. Otherwise, it is a weighted color whose weight is one and whose color is c_{A}+c_{B}(w_{B}/(1−w_{A})). This is the saturated color whose color is in proportion to A_{w}, and to B_{w} in proportion to 1−w_{A} (not in proportion to w_{B}). Note that Sum-to-saturation(A_{w},B_{w}) is equal to A_{w} if A_{w} is saturated.

$${S}_{w} = [ \begin{matrix}{A}_{w} + {B}_{w} & ( {w}_{A} + {w}_{B} ) \leq 1 \\ [ {c}_{A} + {c}_{B} ( \frac{{w}_{B}}{1 - ( {w}_{A} )} ) , 1 ] & otherwise\end{matrix}$$

### Vertex and Fragment Shaders

Many of the techniques described herein can be implemented using modern graphics hardware (GPUs), for example as graphics “shaders”, so as to take advantage of the available increase in performance. Such graphics hardware can be included as part of player 704 in light-field image data acquisition device 709 or in player device 800. For explanatory purposes, the algorithms are described herein in prose and pseudocode, rather than in actual shader language of a specific graphics pipeline.

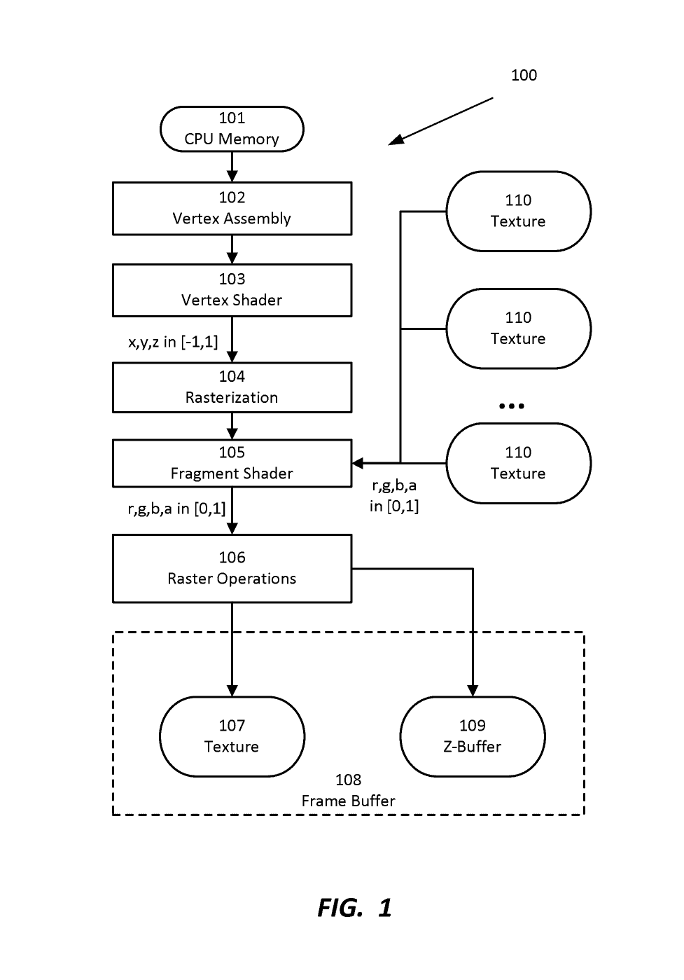

Referring now to FIG. 1, there is shown a flow diagram depicting a sequence of operations, referred to as a graphics pipeline 100, performed by graphics hardware according to one embodiment. Vertex assembly module 102 reads data describing triangle vertex coordinates and attributes (e.g., positions, colors, normals, and texture coordinates) from CPU memory 101 and organizes such data into complete vertexes. Vertex shader 103, which may be an application-specified program is run on each vertex, generating output coordinates in the range [−1,1] and arbitrary floating-point parameter values. Rasterization module 104 organizes the transformed vertexes into triangles and rasterizes them; this involves generating a data structure called a fragment for each frame-buffer pixel whose center is within the triangle. Each fragment is initialized with parameter values, each of which is an interpolation of that parameter as specified at the (three) vertexes generated by vertex shader 103 for the triangle. While the interpolation is generally not a linear one, for illustrative purposes a linear interpolation is assumed.

Fragment shader 105, which may be an application-specified program, is then executed on each fragment. Fragment shader 105 has access to the interpolated parameter values generated by rasterization module 104, and also to one or more textures 110, which are images that are accessed with coordinates in the range [0,1]. Fragment shader 105 generates an output color (each component in the range [0,1]) and a depth value (also in the range [0,1]). The corresponding pixel in frame buffer 108 is then modified based on the fragment's color and depth values. Any of a number of algorithms can be used, including simple replacement (wherein the pixel in frame-buffer texture 107 takes the color value of the fragment), blending (wherein the pixel in frame-buffer texture 107 is replaced by a linear (or other) combination of itself and the fragment color), and depth-buffering (a.k.a. z-buffering, wherein the fragment depth is compared to the pixel's depth in z-buffer 109, and only if the comparison is successful (typically meaning that the fragment depth is nearer than the pixel depth) are the values in frame-buffer texture 107 and z-buffer 109 values replaced by the fragment's color and depth).

Configuration of graphics pipeline 100 involves generating parameters for the operation of vertex shader 103 and fragment shader 105. Once graphics pipeline 100 has been configured, vertex shader 103 is executed for each vertex, and fragment shader 105 is executed for each fragment. In this manner, all vertexes are processed identically, as are all fragments. In at least one embodiment, vertex shader 103 and fragment shader 105 may include conditional execution, including branches based on the results of arithmetic operations.

In at least one embodiment, the system uses known texture-mapping techniques, such as those described in OpenGL Programming Guide: The Official Guide to Learning OpenGL, Version 4.3 (8th Edition). These texture-mapping techniques may be performed by any of several components shown in FIG. 1; in at least one embodiment, such functionality may be distributed among two or more components. For example, texture coordinates may be provided with vertexes to the system from CPU memory 101 via vertex assembly module 102, or may be generated by vertex shader 103. In either case, the texture coordinates are interpolated to pixel values by rasterization module 104. Fragment shader 105 may use these coordinates directly, or modify or replace them. Fragment shader 105 may then access one or more textures, combine the obtained colors in various ways, and use them to compute the color to be assigned to one or more pixels in frame buffer 108.

### The Compressed Light-field

In at least one embodiment, the compressed light-field consists of one or more extended-depth-of-field (EDOF) views, as well as depth information for the scene. Each EDOF view has a center of perspective, which is the point on the entrance pupil of the camera from which it appears the image is taken. Typically one EDOF view (the center view) has its center of perspective at the center of the entrance pupil. Other EDOF views, if present, have centers of perspective at various transverse displacements from the center of the entrance pupil. These images are referred to as hull views, because the polygon that their centers of perspective define in the plane of the entrance pupil is itself a convex hull of centers of perspective. The hull views are shifted such that an object on the plane of focus has the same coordinates in all views, as though they were captured using a tilt-shift lens, with no tilt.

Relative center of perspective (RCoP) is defined as the 2D displacement on the entrance pupil of a view's center of perspective (CoP). Thus the RCoP of the center view may be the 2D vector [0,0]. Hull views have non-zero RCoPs, typically at similar distances from [0,0] (the center of the entrance pupil).

The depth information in the compressed light-field may take many forms. In at least one embodiment, the depth information is provided as an additional component to the center view—a lambda depth value associated with each pixel's color. Such a view, whose pixels are each tuples containing a color and a lambda depth, is referred to herein as a mesh view. The depth information may also be specified as an image with smaller dimensions than the center view, either to save space or to simplify its (subsequent) conversion to a triangle mesh. Alternatively, it may be specified as an explicit mesh of triangles that tile the area of the center view. The hull views may also include depth information, in which case they too are mesh views.

Any suitable algorithm can be used for projecting light-field images to extended-depth-of-field views, as is well known in the art. The center and hull views may also be captured directly with individual 2D cameras, or as a sequence of views captured at different locations by one or more 2D cameras. The appropriate shift for hull views may be obtained, for example, by using a tilt-shift lens (with no tilt) or by shifting the pixels in the hull-view images.

The center and hull views may be stored in any convenient format. In at least one embodiment, a compressed format (such as JPEG) is used. In at least one embodiment, a compression format that takes advantage of similarities in groups of views (e.g., video compressions such as H.264 and MPEG) may be used, because the center and hull views may be very similar to one another.

### Player Pre-Processing

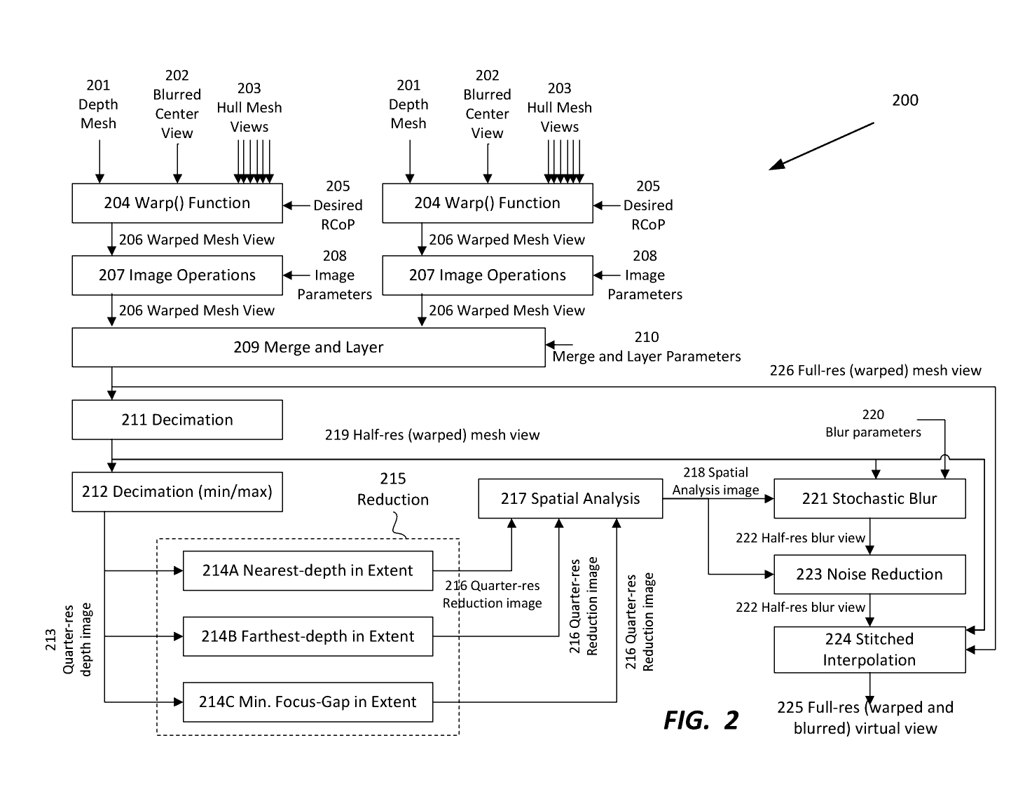

Referring now to FIG. 2, there is shown player rendering loop 200, including steps for processing and rendering multiple compressed light-field images, according to one embodiment. In at least one embodiment, before player 704 begins executing loop 200 to render the compressed light-field image data at interactive rates, it makes several preparations, including conversion of provided data to assets that are amenable to high-performance execution. Some of these preparations are trivial, e.g., extracting values from metadata and converting them to internal variables. Following are some of the assets that require significant preparation.

### Depth Mesh 201

In at least one embodiment, depth mesh 201 is created, if it is not already included in the compressed light-field image data. In at least one embodiment, depth mesh 201 may contain the following properties:
The mesh tiles the center view in x and y, and may be extended such that it tiles a range beyond the edges of the center view.
The triangles are sized so that the resulting tessellated surface approximates the true lambda depth values of the pixels in the center view, and so that the number of triangles is not so large as to impose an unreasonable rendering burden.
The z values of the mesh vertexes are lambda-depth values, which are selected so that the resulting tessellated surface approximates the true lambda-depth values of the pixels in the center view.
Each triangle is labeled as either surface or silhouette. Each surface triangle represents the depth of a single surface in the scene. Silhouette triangles span the distance between two (or occasionally three) objects in the scene, one of which occludes the other(s).
Each silhouette triangle includes a flattened lambda-depth value, which represents the lambda depth of the farther object of the two (or occasionally three) being spanned.
Ideally, the near edges of silhouette triangles align well with the silhouette of the nearer object that they span.

Any of a number of known algorithms can be used to generate 3D triangle meshes from an array of regularly spaced depths (a depth image). For example, one approach is to tile each 2×2 square of depth pixels with two triangles. The choice of which vertexes to connect with the diagonal edge may be informed by depth values of opposing pairs of vertexes (e.g., the vertexes with more similar depths may be connected, or those with more dissimilar depths may be connected). In at least one embodiment, to reduce the triangle count, the mesh may be decimated, such that pairs of triangles correspond to 3×3, 4×4, or larger squares of depth pixels. This decimation may be optimized so that the ideal of matching near edges of silhouette triangles to the true object silhouettes is approached. This may be performed by choosing the location of the vertex in each N×N square such that it falls on an edge in the block of depth pixels, or at corners in such edges. Alternatively, the mesh may be simplified such that triangle sizes vary based on the shape of the lambda surface being approximated.

Categorization of triangles as surface or silhouette may be determined as a function of the range of lambda-depth values of the three vertexes. The threshold for this distinction may be computed as a function of the range of lambda-depth values in the scene.

The flattened-depth for silhouette triangles may be selected as the farthest of the three vertex lambda depths, or may be computed separately for the vertexes of each silhouette triangle so that adjacent flattened triangles abut without discontinuity. Other algorithms for this choice are possible.

### Hull Mesh Views 203

If per-pixel lambda-depth values are not provided for the hull views (that is, if the hull views are not stored as mesh views in the compressed light-field) then player 704 can compute these pixel lambda-depth values prior to rendering the compressed light-field image data. One method is to use the Warp( ) algorithm, described below, setting the desired center of perspective to match the actual center of perspective of the hull view. This has the effect of reshaping depth mesh 201 while applying no distortion to the hull view. Thus the lambda-depth values computed by warping depth mesh 201 are applied directly to the hull view, which is the best approximation.

### Blurred Center View 202

In at least one embodiment, a substantially blurred version of center view 202 may be generated using any of several well-known means. Alternatively, a data structure known in the art as a MIPmap may be computed, comprising a stack of images with progressively smaller pixel dimensions.

### Stochastic Sample Pattern

In at least one embodiment, one or more circular patterns of sample locations may be generated. To minimize artifacts in the computed virtual view, the sample locations in each pattern may be randomized, using techniques that are well known in the art. For example, sample locations within a circular region may be chosen with a dart-throwing algorithm, such that their distribution is fairly even throughout the region, but their locations are uncorrelated. Adjacent pixels in the virtual view may be sampled using differing sample patterns, either by (pseudorandom) selection of one of many patterns, or by (pseudorandom) rotation a single pattern.

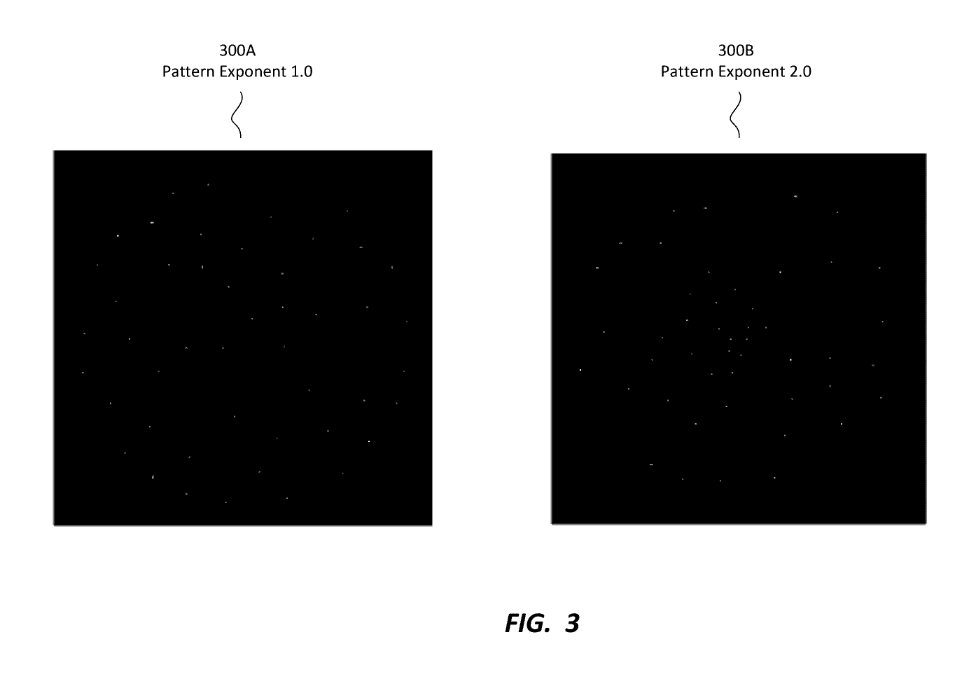

Referring now to FIG. 3, there are shown two examples of stochastic patterns 300A, 300B, with 64 sample locations each.

### Player Rendering Loop 200

After any required assets have been created, player 704 begins rendering images. In at least one embodiment, this is done by repeating steps in a rendering loop 200, as depicted in FIG. 2. In at least one embodiment, all the operations in rendering loop 200 are executed for each new virtual view of the interactive animation of the light-field picture. As described above, player 704 can be implemented as part of a light-field capture device such as a camera 700, or as part of a stand-alone player device 800, which may be a personal computer, smartphone, tablet, laptop, kiosk, mobile device, personal digital assistant, gaming device, wearable device, or any other type of suitable electronic device.

Various stages in player rendering loop 200 produce different types of output and accept different types of input, as described below:
Hull mesh views 203, warped mesh view 206, full-res (warped) mesh view 226, and half-res (warped) mesh view 219) are mesh images. In at least one embodiment, these include three color channels (one for each of red, green, and blue), as well as an alpha channel that encodes lambda values, as described in more detail below.
Half-res blur view 222 is a blur image. In at least one embodiment, this includes three color channels (one for each of red, green, and blue), as well as an alpha channel that encodes a stitch factor, as described in more detail below.
Quarter-res depth image 213 is a depth image. In at least one embodiment, this includes a channel for encoding maximum lambda, a channel for encoding minimum lambda, and a channel for encoding average lambda, as described in more detail below.
In at least one embodiment, reduction images 216 include a channel for encoding smallest extent, a channel for encoding largest extent, and one or more channels for encoding mid-level extent, as described in more detail below.
In at least one embodiment, spatial analysis image 218 includes a channel for encoding pattern exponent, a channel for encoding pattern radius, and a channel for encoding bucket spread, as described in more detail below.

Each of the steps of rendering loop 200, along with the above-mentioned images and views, is described in turn, below.

### Warp( ) Function 204

In at least one embodiment, a Warp( ) function 204 is performed on each view. In at least one embodiment, Warp( ) function 204 accepts blurred center view 202, depth mesh 201 corresponding to that center view 202, and a desired relative center of perspective (desired RCoP) 205.

Warp( ) function 204 may be extended to accept hull mesh views 203 (rather than center view 202, but still with a depth mesh 201 that corresponds to center view 202) through the addition of a fourth parameter that specifies the RCoP of the hull view. The extended Warp( ) function 204 may compute the vertex offsets as functions of the difference between the desired RCoP 205 and the hull-view RCoP. For example, if a hull view with an RCoP to the right of center is to be warped toward a desired RCoP 205 that is also right of center, the shear effect will be reduced, becoming zero when the hull-view RCoP matches the desired RCoP 205. This is expected, because warping a virtual view to a center of perspective that it already has should be a null operation.

In the orthographic space of a virtual view, a change in center of perspective is equivalent to a shear operation. The shear may be effected on a virtual view with a corresponding depth map by moving each pixel laterally by x and y offsets that are multiples of the pixel's lambda values. For example, to distort a center view to simulate a view slightly to the right of center (looking from the camera toward the scene), the x value of each center-view pixel may be offset by a small positive constant factor times its lambda depth. Pixels nearer the viewer have negative lambdas, so they move left, while pixels farther from the viewer have positive lambdas, so they move right. The visual effect is as though the viewer has moved to the right.

Such a shear (a.k.a. warp) may be implemented using modern graphics hardware. For example, in the system described herein, depth mesh 201 is rendered using vertex shader 103 that translates vertex x and y coordinates as a function of depth; the virtual view to be sheared is texture-mapped onto this sheared mesh. In at least one embodiment, the specifics of the texture-mapping are as follows: texture coordinates equal to the sheared vertex position are assigned by vertex shader 103, interpolated during rasterization, and used to access the virtual-view texture by fragment shader 105.

Texture-mapping has the desirable feature of stretching pixels, so that the resulting image has no gaps (as would be expected if the pixels were simply repositioned). In some cases, however, the stretch may be severe for triangles that span large lambda-depth ranges. Methods to correct for extreme stretch are described below, in the section titled Warp with Occlusion Filling.

As described, the warp pivots around lambda-depth value zero, so that pixels with zero lambda depths do not move laterally. In at least one embodiment, the pivot depth is changed by computing depth-mesh vertex offsets as a function of the difference between vertex lambda depth and the desired pivot lambda depth. Other distortion effects may be implemented using appropriate equations to compute the x and y offsets. For example, a “dolly zoom” effect may be approximated by computing an exaggerated shear about a dolly pivot distance. See, for example, U.S. patent application Ser. No. 14/311,592, for “Generating Dolly Zoom Effect Using Light-field Image Data” (Atty. Docket No. LYT003-CONT), filed Jun. 23, 2014 and issued on Mar. 3, 2015 as U.S. Pat. No. 8,971,625, the disclosure of which is incorporated herein by reference.

The result of Warp( ) function 204 is a warped mesh view 206, including a color value at each pixel. The term “mesh view” is used herein to describe a virtual view that includes both a color value and a lambda-depth value at each pixel. There are several applications for such lambda-depth values, as will be described in subsequent sections of this document.

In some cases, triangles in warped mesh view 206 may overlap. In such cases, the z-buffer may be used to determine which triangle's pixels are visible in the resulting virtual view. In general, pixels rasterized from the nearer triangle are chosen, based on a comparison of z-buffer values. Triangles whose orientation is reversed may be rejected using back-facing triangle elimination, a common feature in graphics pipelines.

The result of Warp( ) function 204 may also include a lambda-depth value, assigned by correspondence to depth mesh 201. The pixel lambda-depth value may alternatively be assigned as a function of the classification—surface or silhouette—of the triangle from which it was rasterized. Pixels rasterized from surface triangles may take depth-mesh lambda depths as thus far described. But pixels rasterized from silhouette triangles may take instead the flattened lambda depth of the triangle from which they were rasterized.

The z-buffer algorithm may also be modified to give priority to a class of triangles. For example, surface and silhouette triangles may be rasterized to two different, non-overlapping ranges of z-buffer depth values. If the range selected for surface triangles is nearer than the range selected for silhouette triangles, then pixels rasterized from silhouette triangles will always be overwritten by pixels rasterized from surface triangles.

Warp with Occlusion Filling

Warp( ) function 204 described in the previous section is geometrically accurate at the vertex level. However, stretching pixels of the center view across silhouette triangles is correct only if the depth surface actually does veer sharply but continuously from a background depth to a foreground depth. More typically, the background surface simply extends behind the foreground surface, so changing the center of perspective should reveal otherwise occluded portions of the background surface. This is very different from stretching the center view.

If only a single virtual view is provided in the compressed light-field picture, then nothing is known about the colors of regions that are not visible in that view, so stretching the view across silhouette triangles when warping it to a different RCoP may give the best possible results. But if additional virtual views (e.g., hull views) are available, and these have relative centers of perspective that are positioned toward the edges of the range of desired RCoPs, then these (hull) views may collectively include the image data that describe the regions of scene surfaces that are occluded in the single view, but become visible as that view is warped to the desired RCoP 205. These regions are referred to as occlusions. In at least one embodiment, the described system implements a version of Warp( ) function 204 that supports occlusion filling from the hull views, as follows.

For a specific hull view, player 704 computes the hull-view coordinate that corresponds to the center-view coordinate of the pixel being rasterized by Warp( ) function 204. Because this hull-view coordinate generally does not match the center-view coordinate of the pixel being rasterized, but is a function of the center-view coordinate, its computation relative to the center-view coordinate is referred to herein as a remapping. The x and y remapping distances may be computed as the flattened lambda depth of the triangle being rasterized, multiplied by the difference between desired RCoP 205 and the hull-view RCoP. The x remapping distance depends on the difference between the x values of desired RCoP 205 and the hull-view RCoP, and the y remapping distance depends on the difference between the y values of desired RCoP 205 and the hull-view RCoP. In at least one embodiment, the remapping distances may be computed by vertex shader 103, where they may be added to the center-view coordinate to yield hull-view coordinates, which may be interpolated during rasterization and used subsequently in fragment shader 105 to access hull-view pixels. If warping pivots about a lambda depth other than zero, or if a more complex warp function (such as “dolly zoom”) is employed, the center-view coordinate to which the remap distances are added may be computed independently, omitting the non-zero pivot and the more complex warp function.

Hull views whose RCoPs are similar to desired RCoP 205 are more likely to include image data corresponding to occlusions than are hull views whose RCoPs differ from desired RCoP 205. But only when desired RCoP 205 exactly matches a hull view's RCoP is the hull view certain to contain correct occlusion imagery, because any difference in view directions may result in the desired occlusion being itself occluded by yet another surface in the scene. Thus, occlusion filling is more likely to be successful when a subset of hull views whose RCoPs more closely match the view RCoP are collectively considered and combined to compute occlusion color. This remapping subset of the hull views may be a single hull view, but it may also be two or more hull views. The difference between desired and hull-view RCoP may be computed in any of several different ways, for example, as a 2D Cartesian distance (square root of the sum of squares of difference in x and difference in y), as a rectilinear distance (sum of the differences in x and y), or as the difference in angles about [0,0] (each angle computed as the arc tangent of RCoP x and y).

In at least one embodiment, the hull views are actually hull mesh views 203 (which include lambda-depth at each pixel), and the remapping algorithm may compare the lambda-depth of the hull-view pixel to the flattened lambda depth of the occlusion being filled, accepting the hull-view pixel for remapping only if the two lambda depths match within a (typically small) tolerance. In the case of a larger difference in lambda depths, it is likely that the hull-view remapping pixel does not correspond to the occlusion, but instead corresponds to some other intervening surface. By this means, remapping pixels from some or all of the hull views in the remapping subset are validated, and the others invalidated. Validation may be partial, if the texture-lookup of the remapping pixel samples multiple hull-view pixels rather than only the one nearest to the hull-view coordinate.

In at least one embodiment, the colors of the validated subset of remapping hull view pixels are combined to form the color of the pixel being rasterized. To avoid visible flicker artifacts in animations of desired RCoP, the combining algorithm may be designed to avoid large changes in color between computations with similar desired RCoPs. For example, weighted-color arithmetic may be used to combine the remapped colors, with weights chosen such that they sum to one, and are in inverse proportion to the distance of the hull-image RCoP from the view RCoP. Hull-view pixels whose remapping is invalid may be assigned weights of zero, causing the sum of weights to be less than one. During conversion of the sum of weighted colors back to a color, the gain-up (which is typically the reciprocal of the sum of weights) may be limited to a finite value (e.g., 2.0) so that no single hull-view remapping color is ever gained up an excessively large amount, which may amplify noise and can cause visible flicker artifacts.

The choice of the hull views in the remapping subset may be made once for the entire scene, or may be made individually for each silhouette triangle, or may be made other ways.

When desired RCoP 205 is very similar to the center-view RCoP, it may be desirable to include the center view in the remapping subset, giving it priority over the hull views in this set (that is, using it as the first in the sum of weighted colors, and using sum-to-saturation weighted-color arithmetic). In at least one embodiment, the weight of the center view remapping pixel is computed so that it has the following properties:
It is one when desired RCoP 205 is equal to the center-view RCoP. (This causes the mesh-view output 206 of Warp( ) function 204 to match the center view exactly when desired RCoP 205 matches the center-view RCoP.)
It falls off rapidly as desired RCoP 205 diverges from the center-view RCoP (because hull views have more relevant color information).
The rate of fall-off is a function of the spatial distribution of lambda depths of the silhouette triangle and of desired RCoP 205, being greater when these factors conspire to increase the triangle's distortion (i.e., when the triangle has a large left-to-right change in lambda depths, and the view RCoP moves left or right, or the triangle has a large top-to-bottom change in lambda depths, and the view RCoP moves up or down) and lesser otherwise (e.g., when the triangle has very little change in lambda depth from left to right, and the view RCoP has very little vertical displacement).

The sum of weights of remapping pixels (both center and hull) may be less than one, even if some gain-up is allowed. In this case, the color may be summed to saturation using a pre-blurred version of the stretched center view. The amount of pre-blurring may itself be a function of the amount of stretch in the silhouette triangle. In at least one embodiment, player 704 is configured to compute this stretch and to choose an appropriately pre-blurred image, which has been loaded as part of a “MIPmap” texture. Pre-blurring helps disguise the stretching, which may otherwise be apparent in the computed virtual view.

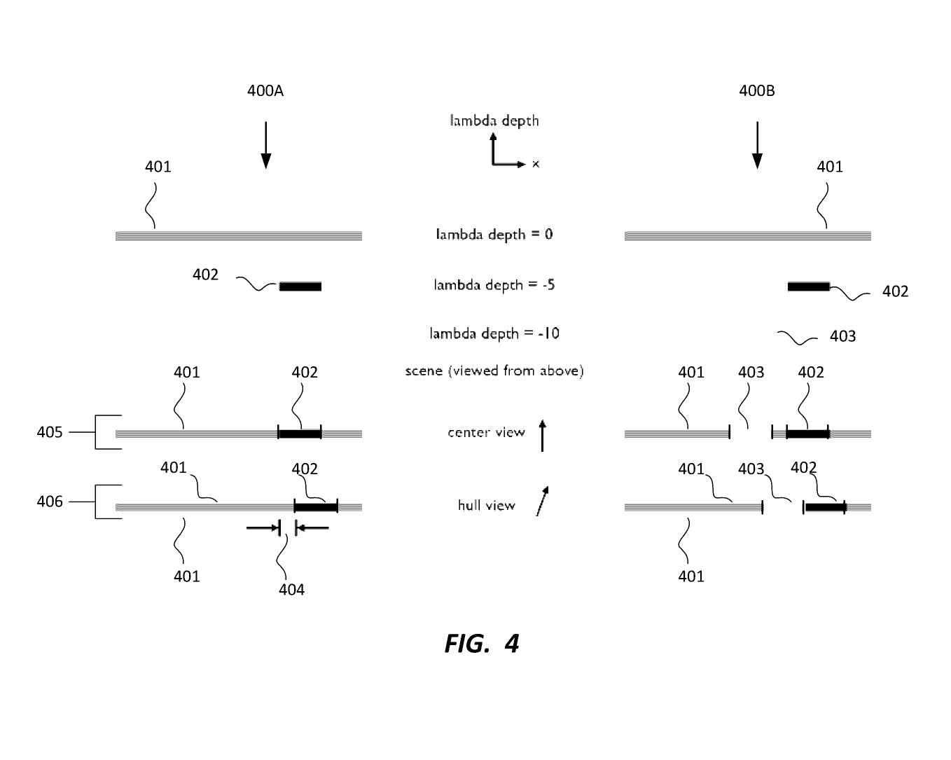

Referring now to FIG. 4, there is shown an example of occlusion processing according to one embodiment. Two examples 400A, 400B of a scene are shown. Scene 400A includes background imagery 401 at lambda depth of zero and an object 402 at lambda depth −5. In center view 405 of scene 400A, object 402 obscures part of background imagery 401. In hull view 406 of scene 400A, object 402 obscures a different part of background imagery 401. The example shows a range 404 of background imagery 401 that is obscured in center view 405 but visible in hull view 406.

Scene 400B includes background imagery 401 at lambda depth of zero, object 402 at lambda depth −5, and another object 403 at lambda depth −10. In center view 405 of scene 400B, objects 402 and 403 obscure different parts of background imagery 401, with some background imagery 401 being visible between the obscured parts. In hull view 406 of scene 400B, objects 402 and 403 obscure different parts of background imagery 401, with no space between the obscured parts. Objects 402 and 403 different ranges of background imagery 401 in hull view 406 as opposed to center view 405.

### Image Operations 207

The output of Warp( ) function 204 is warped mesh view 206. In at least one embodiment, any number of image operations 207 can be performed on warped mesh view 206. Many such image operations 207 are well known in the art. These include, for example, adjustment of exposure, white balance, and tone curves, denoising, sharpening, adjustment of contrast and color saturation, and change in orientation. In various embodiments, these and other image operations may be applied, in arbitrary sequence and with arbitrary parameters. If appropriate, image parameters 208 can be provided for such operations 207.

### Merge and Layer 209

Multiple compressed light-field images, with their accompanying metadata, may be independently processed to generate warped mesh views 207. These are then combined into a single warped mesh view 226 in merge and layer stage 209. Any of a number of different algorithms for stage 209 may be used, from simple selection (e.g., of a preferred light-field image from a small number of related light-field images, such as would be captured by a focus bracketing or exposure bracketing operation), through complex geometric merges of multiple light-field images (e.g., using the lambda-depth values in the warped and image-processed mesh views as inputs to a z-buffer algorithm that yields the nearest color, and its corresponding lambda depth, in the generated mesh view). Spatially varying effects are also possible, as functions of each pixel's lambda-depth value, and/or functions of application-specified spatial regions. Any suitable merge and layer parameters 210 can be received and used in merge and layer stage 209.

### Decimation 211, 212

In at least one embodiment, mesh view 226 generated by merge and layer stage 209 may be decimated 211 prior to subsequent operations. For example, the pixel dimensions of the mesh view that is sent on to stochastic blur stage 221 (which may have the greatest computational cost of any stage) may be reduced to half in each dimension, reducing pixel count, and consequently the cost of stochastic blur calculation, to one quarter. Decimation filters for such an image-dimension reduction are well known in the art. Different algorithms may be applied to decimate color (e.g., a 2×2 box kernel taking the average, or a Gaussian kernel) and to decimate lambda depth (e.g., a 2×2 box kernel taking average, minimum, or maximum). Other decimation ratios and algorithms are possible.

The result of decimation stage 211 is half-res warped mesh view 219. Further decimation 212 (such as min/max decimation) may be applied to mesh view 219 before being sent on to reduction stage 215. In at least one embodiment, reduction stage 215 may operate only on lambda depth, allowing the color information to be omitted. However, in at least one embodiment, reduction stage 215 may require both minimum and maximum lambda-depth values, so decimation stage 212 may compute both.

### Reduction 215

The result of decimation 212 is quarter-res depth image 213. In at least one embodiment, quarter-res depth image 213 is then provided to reduction stage 215, which produces quarter-res reduction image(s) 216. In at least one embodiment, image(s) 216 have the same pixel dimensions as quarter-res depth image 213. Each output pixel in quarter-res reduction image(s) 216 is a function of input pixels within its extent—a circular (or square) region centered at the output pixel, whose radius (or half width) is the extent radius (E). For example, a reduction might compute the minimum lambda depth in the 121 pixels within its extent of radius five. (Pixel dimensions of the extent are 2E+1=11, area of the extent is then 11×11=121.) If the reduction is separable, as both minimum and maximum are, then it may be implemented in two passes: a first pass that uses a (1)×(2E+1) extent and produces an intermediate reduction image, and a second pass that performs a (2E+1)×(1) reduction on the intermediate reduction image, yielding the desired reduction image 216 (as though it had been computed in a single pass with a (2E+1)×(2E+1) extent, but with far less computation required).

In at least one embodiment, both nearest-lambda 214A and farthest-lambda 214B reductions may be computed, and each may be computed for a single extent radius, or for multiple extent radii. Near lambda depths are negative, and far lambda depths are positive, so that the nearest lambda depth is the minimum lambda depth, and the farthest lambda depth is the maximum lambda depth. In at least one embodiment, a minimum-focus-gap reduction 214C may also be computed. Focus gap is the (unsigned) lambda depth between a pixel's lambda depth and the virtual-camera focal plane. If the virtual-camera has a tilted focal plane, its focus depth may be computed separately at every pixel location. Otherwise it is a constant value for all pixels.

In at least one embodiment, before reduction image 216 is computed, the reduction extent radius (or radii) is/are specified. Discussion of extent-radius computation appears in the following section (Spatial Analysis 217). The extent radii for the nearest-lambda and farthest-lambda reductions are referred to as Eₙₑₐᵣ and E_{far}, and the extent radius for the minimum-focus-gap reduction is referred to as E_{gap}.

### Spatial Analysis 217

In spatial analysis stage 217, functions of the reduction images are computed that are of use to subsequent stages, including stochastic blur stage 221 and noise reduction stage 223. Outputs of spatial analysis stage 217 can include, for example, Pattern Radius, Pattern Exponent, and/or Bucket Spread. The pixel dimensions of the spatial-analysis image(s) 218 resulting from stage 217 may match the pixel dimensions of reduction image(s) 216. The pixel dimensions of spatial-analysis image(s) 218 may match, or may be within a factor of two, of the pixel dimensions of the output of stochastic blur stage 221 and noise reduction stage 223. Thus, spatial-analysis outputs are computed individually, or nearly individually, for every pixel in the stochastic blur stage 221 and noise reduction stage 223. Each of these outputs is discussed in turn.

### 1) Pattern Radius

In the orthographic coordinates used by the algorithms described herein, a (second) pixel in the mesh view to be stochastically blurred can contribute to the stochastic blur of a (first) pixel if the coordinates of that second pixel [x₂,y₂,z₂] is within the volume of confusion centered at [x1,y₁,z_{focus}], where x₁ and y₁ are the image coordinates of the first pixel, and Z_{focus} is the lambda depth of the focal plane at the first pixel.

Ideally, to ensure correct stochastic blur when processing a pixel, all pixels within a volume of confusion would be discovered and processed. However, inefficiencies can result and performance may suffer if the system processes unnecessary pixels that cannot be in the volume of confusion. Furthermore, it is useful to determine which pixels within the volume of confusion should be considered. These pixels may or may not be closest to the pixel being processed.

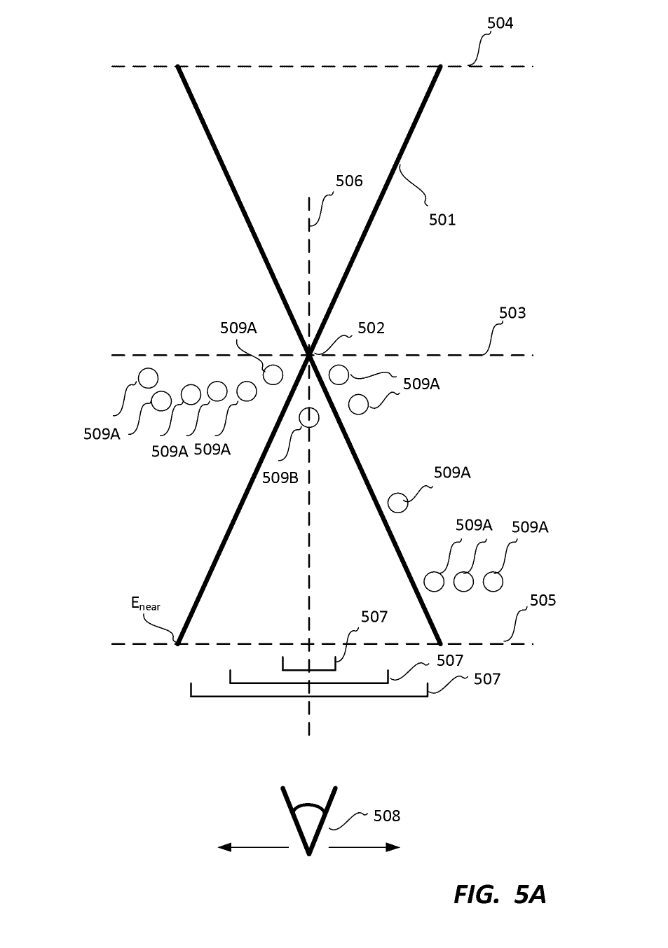

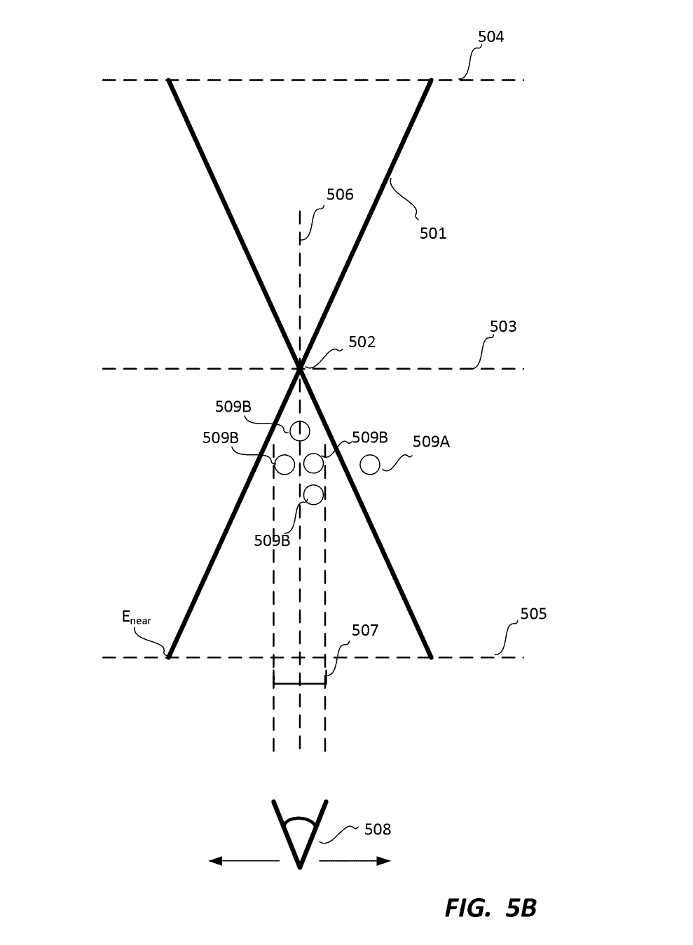

Referring now to FIG. 5A, there is shown an example of a volume of confusion 501 representing image data to be considered in applying blur for a pixel 502, according to one embodiment. Lambda depth 504 represents the farthest depth from viewer 508, and lambda depth 505 represents the nearest. Several examples of pixels are shown, including pixels 509A outside volume of confusion 501 and pixels 509B within volume of confusion 501. (Pixels 509A, 509B are enlarged in the Figure for illustrative purposes.)

In one embodiment, a conservative Pattern Radius is computed, to specify which pixels are to be considered and which are not. In at least one embodiment, the Pattern Radius is used in the stochastic blur stage 221, so as to consider those pixels within the Pattern Radius of the pixel 502 being stochastically blurred when pixel 502 is being viewed by viewer 508 at a particular viewpoint. FIG. 5A depicts several different Pattern Radiuses 507, all centered around center line 506 that passes through pixel 502. The particular Pattern Radius 507 to be used varies based on depth and view position 508. For example, a smaller Pattern Radius 507 may be used for depths closer to focal plane 503, and a larger Pattern Radius 507 may be used for depths that farther from focal plane 503.

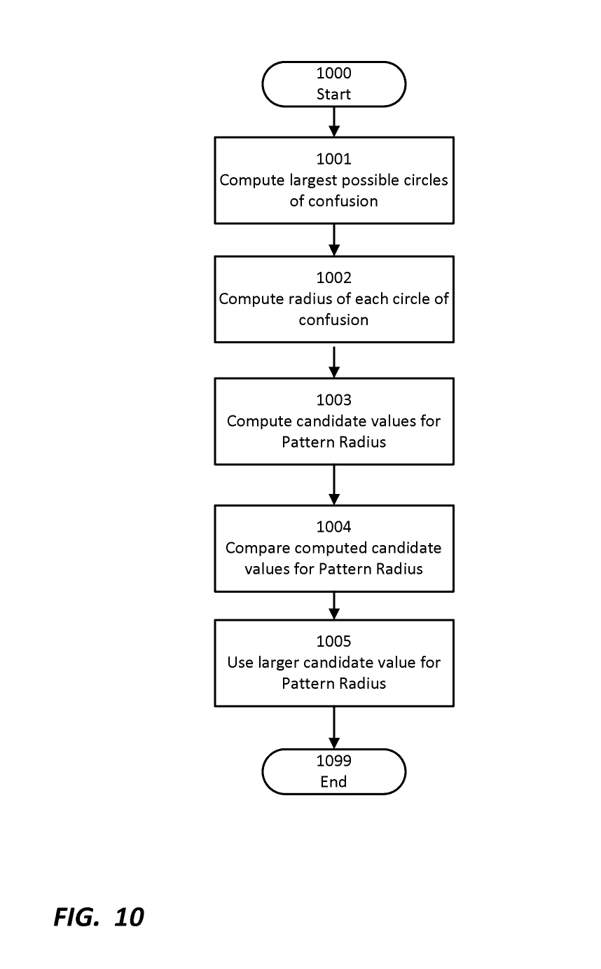

Referring now also to FIG. 10, there is shown a flow diagram depicting a method for determining a pattern radius, according to one embodiment. First the largest possible circles of confusion for a specific focal-plane depth are computed 1001 as the circles of confusion at the nearest and farthest lambda depths 505, 504 of any pixels in the picture. In at least one embodiment, this is based on computations performed during pre-processing. Then, the radius of each circle of confusion is computed 1002 as the unsigned lambda-depth difference between the focal plane and the extreme pixel lambda depth, scaled by B. Focal-plane tilt, if specified by the virtual camera, may be taken into account by computing the lambda-depth differences in the corners of picture in which they are largest.

The computed maximum circle of confusion radius at the nearest lambda-depth in the scene may be used as Eₙₑₐᵣ (the extent radius for the nearest-lambda depth image reduction), and the computed maximum circle of confusion radius at the farthest lambda-depth in the scene may be used as E_{far} (the extent radius for the farthest-lambda depth image reduction). In step 1003, using these extent radii, the nearest-lambda and farthest-lambda reductions are used to compute two candidate values for the Pattern Radius at each first pixel to be stochastically blurred: the CoC radius computed for the nearest lambda-depth in extent Eₙₑₐᵣ, and the CoC radius computed for the farthest lambda-depth in extent E_{far}. In step 1004, these are compared, and whichever CoC radius is larger is used 1005 as the value for the Pattern Radius 507 for pixel 502.

As mentioned earlier, both nearest-lambda and farthest-lambda reductions may be computed for multiple extent radii. If additional radii are computed, they may be computed as fractions of the radii described above. For example, if Eₙₑₐᵣ is 12, and the nearest-lambda reduction is computed for four extent radii, these extent radii may be selected as 3, 6, 9 and 12. Additional extents may allow the Pattern Radius for a first pixel to be made smaller than would otherwise be possible, because a CoC radius computed for a larger extent may be invalid (since the pixel depths that result in such a CoC radius cannot be in the volume of confusion).

For example, suppose the focal-plane is untilted with lambda depth zero, and suppose B=1. Let there be two extent radii for the farthest-lambda reduction, 5 and 10, with reductions of 3 and 4 at a first pixel to be blurred. If only the larger-radius reduction were available, the CoC radius computed for the farthest lambda-depth in this extent would be 4B=4(1)4. But the CoC radius for the farthest lambda depth in the smaller-radius reduction is 3B=3(1)=3, and we know that any second pixel with lambda depth 4 must not be in the smaller extent (otherwise the smaller extent's reduction would be 4) so it must be at least five pixels from the center of the extent. But a second pixel that is five pixels from the center of the extent must have a lambda depth of at least 5 to be within the volume of confusion (which has edge slope B=1), and we know that no pixel in this extent has a lambda depth greater than 4 (from the larger-radius reduction), so no second pixel in the larger extent is within the volume of confusion. Thus, the maximum CoC radius remains 3, which is smaller than the CoC radius of 4 that was computed using the single larger-radius reduction. (And would have been used had there been no smaller extent.)

Referring now to FIG. 5B, there is shown another example of volume of confusion 501 representing image data to be considered in applying blur for pixel 502, according to one embodiment. Pixels 509B lie within volume of confusion 501, and pixel 509A is outside it. A calculation is performed to determine the maximum radius of volume of confusion 501. The z-value of the nearest pixel to viewer 508 along the z-axis within that radius is determined. Then, the same computation is made for several different, smaller radii; for example, it can be performed for four different radii. For each selected radius, the z-value of the nearest pixel to viewer 508 along the z-axis within that radius is determined. Any suitable step function can be used for determining the candidate radii.

For any particular radius, a determination is made as to whether any pixels within that radius are of interest (i.e., within the volume of confusion). This can be done by testing all the pixels within the specified region, to determine whether they are within or outside the volume of confusion. Alternatively, it can be established with statistical likelihood by testing only a representative subset of pixels within the region. Then, the smallest radius having pixels of interest is used as Pattern Radius 507.

In at least one embodiment, for best sampling results, the sample pattern should be large enough to include all sample pixels that are in the volume of confusion for the center pixel (so that no color contributions are omitted) and no larger (so that samples are not unnecessarily wasted where there can be no color contribution). The sample pattern may be scaled by scaling the x and y coordinates of each sample location in the pattern by Pattern Radius 507. The sample x and y coordinates may be specified relative to the center of the sample pattern, such that scaling these coordinates may increase the radius of the pattern without affecting either its circular shape or the consistency of the density of its sample locations.

### 2) Pattern Exponent

In at least one embodiment, stochastic blur stage 221 may use Pattern Radius 507 to scale the sample locations in a stochastic sample pattern. The sample locations in this pattern may be (nearly) uniformly distributed within a circle of radius one. When scaled, the sample locations may be (nearly) uniformly distributed in a circle with radius equal to Pattern Radius 507. If Pattern Radius 507 is large, this may result in a sample density toward the center of the sample pattern that is too low to adequately sample a surface in the scene that is nearly (but not exactly) in focus.

To reduce image artifacts in this situation, in at least one embodiment a Pattern Exponent may be computed, which is used to control the scaling of sample locations in the stochastic blur pattern, such that samples near the center of the unscaled pattern remain near the center in the scaled pattern. To effect this distorted scaling, sample locations may be scaled by the product of the Pattern Radius with a distortion factor, which factor is the distance of the original sample from the origin (a value in the continuous range [0,1]) raised to the power of the Pattern Exponent (which is never less than one). For example, if the Pattern Radius is four and the Pattern Exponent is two, a sample whose original distance from the origin is ½ has its coordinate scaled by 4(1/2)²=1, while a sample near the edge of the pattern whose original distance from the origin is 1 has its coordinate scaled by 4(1)²=4.

Any of a number of algorithms for computing the Pattern Exponent may be used. For example, the Pattern Exponent may be computed so as to hold constant the fraction of samples within a circle of confusion at the minimum-focus-gap reduction. Alternatively, the Pattern Exponent may be computed so as to hold constant the radius of the innermost sample in the stochastic pattern. Alternatively, the Pattern Exponent may be computed so as to hold a function of the radius of the innermost sample constant, such as the area of the circle it describes.

### 3) Bucket Spread

In at least one embodiment, Bucket Spread may be computed as a constant, or as a small constant times the range of lambda depths in the scene, or as a small constant times the difference between the farthest-lambda reduction and the focal-plane lambda depth (the result clamped to a suitable range of positive values), or in any of a number of other ways.

### Stochastic Blur 221

In at least one embodiment, stochastic blur stage 221 computes the blur view individually and independently for every pixel in the mesh view being stochastically blurred. In at least one embodiment, stochastic blur stage 221 uses blur parameters 200.

### 1) Single-Depth View Blur

In the simplest case, consider a mesh view in which every pixel has the same lambda depth, L. Given a focal-plane lambda depth of F, the circle of confusion radius C for each pixel would be

C=B|F−L|

Ideally the blur computed for a single pixel in the mesh view (the center pixel) is a weighted sum of the color values of pixels (referred to as sample pixels) that are within a circle of confusion centered at the center pixel. The optics of camera blur are closely approximated when each sample pixel is given the same weight. But if the decision of whether a pixel is within the circle of confusion is discrete (e.g., a pixel is within the CoC if its center point is within the CoC, and is outside otherwise) then repeated computations of the blurred view, made while slowly varying F or B, will exhibit sudden changes from one view to another, as pixels move into or out of the circles of confusion. Such sudden view-to-view changes are undesirable.

To smooth things out, and to make the blur computation more accurate, the decision of whether a pixel is within the CoC or not may be made to be continuous rather than discrete. For example, a 2D region in the image plane may be assigned to each sample pixel, and the weight of each sample pixel in the blur computation for a given center pixel may be computed as the area of the intersection of its region with the CoC of the center pixel (with radius C), divided by the area of the CoC of the center pixel (again with radius C). These weights generally change continuously, not discretely, as small changes are made to the radius of the CoC and the edge of the CoC sweeps across each pixel region.

Furthermore, if sample-pixel regions are further constrained to completely tile the view area, without overlap, then the sum of the weights of sample pixels contributing to the blur of a given center pixel will always be one. This occurs because the sum of the areas of intersections of the CoC with pixel regions that completely tile the image must be equal to the area of the CoC, which, when divided by itself, is one. In at least one embodiment, such a tiling of pixel regions may be implemented by defining each sample pixel's region to be a square centered at the pixel, with horizontal and vertical edges of length equal to the pixel pitch. In other embodiments, other filings may be used.

### 2) Multi-Depth View Blur

In the case of blur computation for a general mesh view, each sample pixel has an individual lambda depth Lₛ, which may differ from the lambda depths of other pixels. In this case, the same approach is used as for the single-depth view blur technique described above, except that the CoC radius Cₛ is computed separately for each sample pixel, based on its lambda depth Lₛ.

Cₛ=B|F−Lₛ|

The weight of each sample pixel is the area of the intersection of its region with the CoC of the center pixel (with radius Cₛ), divided by the area of the CoC of the center pixel (with radius Cₛ). If the lambda depths of all the sample pixels are the same, then this algorithm yields the same result as the single-depth view blur algorithm, and the sum of the sample-pixel weights will always be one. But if the lambda depths of sample pixels differ, then the sum of the weights may not be one, and indeed generally will not be one.

The non-unit sum of sample weights has a geometric meaning: it estimates the true amount of color contribution of the samples. If the sum of sample weights is less than one, color that should have been included in the weighted sum of samples has somehow been omitted. If it is greater than one, color that should not have been included this sum has somehow been included. Either way the results are not correct, although a useful color value for the sum may be obtained by dividing the sum of weighted sample colors by the sum of their weights.

### 3) Buckets

The summation of pixels that intersect the Volume of Confusion, which is computed by these algorithms, is an approximation that ignores the true paths of light rays in a scene. When the sum of sample weights is greater than one, a useful geometric intuition is that some sample pixels that are not visible to the virtual camera have been included in the sum, resulting in double counting that is indicated by the excess weight. To approximate a correct sum, without actually tracing the light rays to determine which are blocked, the sample pixels may be sorted by their lambda depths, from nearest to farthest, and then sequential sum-to-saturation arithmetic may be used to compute the color sum. Such a sum would exclude the contributions of only the farthest sample pixels, which are the pixels most likely to have been obscured.

While generalized sorting gives excellent results, it is computationally expensive and may be infeasible in an interactive system. In at least one embodiment, the computation cost of completely sorting the samples is reduced by accumulating the samples into two or more weighted colors, each accepting sample pixels whose lambda depths are within a specified range. For example, three weighted colors may be maintained during sampling:
a mid-weighted color, which accumulates sample pixels whose lambda depths are similar to the lambda depth of the center pixel;
a near-weighted color, which accumulates sample pixels whose lambda depths are nearer than the near limit of the mid weighted color; and
a far-weighted color, which accumulates sample pixels whose lambda depths are farther than the far limit of the mid-weighted color.

Samples are accumulated for each weighted color as described above for multi-depth view blur. After all the samples have been accumulated into one of the near-, mid-, and far-weighted colors, these three weighted colors are themselves summed nearest to farthest, using sum-to-saturation arithmetic. The resulting color can provide a good approximation of the color computed by a complete sorting of the samples, with significantly lower computational cost.

The range-limited weighted colors into which samples are accumulated are referred to herein as buckets—in the example above, the mid bucket, the near bucket, and the far bucket. Increasing the number of buckets may improve the accuracy of the blur calculation, but only if the bucket ranges are specified so that samples are well distributed among the buckets. The three-bucket distinction of mid bucket, near bucket, and far bucket, relative to the lambda depth of the center pixel, is merely an example of one such mechanism for accumulating samples; other approaches may be used. In at least one embodiment, the center pixel positions the mid bucket, and is always included in it. In some cases, either or both of the near bucket and the far bucket may receive no samples.

The range of sample-pixel lambda depths for which samples are accumulated into the mid bucket may be specified by the Bucket Spread output of spatial analysis stage 217. Sample pixels whose lambda depths are near the boundary lambda between two buckets may be accumulated into both buckets, with proportions (that sum to one) being biased toward one bucket or the other based on the exact lambda-depth value.

### 4) Occlusion

In some cases, the sum of the bucket weights is less than one. This suggests that some color that should be included in the sum has been occluded, and therefore omitted. If the color of the occluded color can be estimated, the weighted sum of the near, mid, and far buckets can be summed to saturation with this color, better approximating the correct result.

There are multiple ways that the occluded color can be estimated. For example, the color of the far bucket may be used. Alternatively, a fourth bucket of sample pixels whose lambda depths were in the far-bucket range, but which were not within the Volume of Uncertainty, may be maintained, and this color used. The contributions to such a fourth bucket may be weighted based on their distance from the center pixel, so that the resulting color more closely matches nearby rather than distant pixels.

In another embodiment, a view with multiple color and lambda-depth values per pixel is consulted. Assuming that the multiple color/ depth pairs were ordered, an occluded color at a pixel can be queried as the second color/depth pair. Views with these characteristics are well known in the art, sometimes being called Layered Depth Images.

Summing to saturation with an estimated occlusion color may be inappropriate in some circumstances. For example, summing the estimated occlusion color may be defeated when F (the lambda depth of the focal plane) is less than the lambda depth of the center pixel. Other circumstances in which occlusion summation is inappropriate may be defined.

### 5) Stochastic Sampling

In the above description, stochastic blur stage 221 samples and sums all the pixels that contribute to the volume of confusion for each center pixel. But these volumes may be huge, including hundreds and even many thousands of sample pixels each. Unless the amount of blur is severely limited (thereby limiting the number of pixels in the volume of confusion), this algorithmic approach may be too computationally expensive to support interactive generation of virtual views.

In at least one embodiment, stochastic sampling is used, in which a subset of samples is randomly or pseudo-randomly chosen to represent the whole. The selection of sample locations may be computed, for example, during Player Pre-Processing. The sample locations in this pattern may be distributed such that their density is approximately uniform throughout a pattern area that is a circle of radius one. For example, a dart-throwing algorithm may be employed to compute pseudorandom sample locations with these properties. Alternatively, other techniques can be used.

For each center pixel to be blurred, the pattern may be positioned such that its center coincides with the center of the center pixel. Different patterns may be computed, and assigned pseudo-randomly to center pixels. Alternatively, a single pattern may be pseudo-randomly rotated or otherwise transformed at each center pixel. Other techniques known in the art may be used to minimize the correlation between sample locations in the patterns of adjacent or nearly adjacent center pixels.

In some cases, sample pattern locations may not coincide exactly with sample pixels. Each sample color and lambda depth may be computed as a function of the colors and lambda depths of the sample pixels that are nearest to the sample location. For example, the colors and lambda depths of the four sample pixels that surround the sample location may be bilinearly interpolated, using known techniques; alternatively, other interpolations can be used. If desired, different interpolations may be performed for color and for lambda-depth values.

### 7) Ring-Shaped Sample Regions

Just as each sample pixel may have an assigned region (such as, for example, the square region described in Single-Depth View Blur above), in at least one embodiment each sample in the sample pattern may also have an assigned region. But pixel-sized square regions may not necessarily be appropriate, because the samples may not be arranged in a regular grid, and the sample density may not match the pixel density. Also, the tiling constraint is properly fulfilled for stochastic pattern sampling when the regions of the samples tile the pattern area, not when they tile the entire view. (Area outside the pattern area is of no consequence to the sampling arithmetic.)

Any suitable technique for assigning regions to samples in the sample pattern can be used, as long as it fully tiles the pattern area with no overlap. Given the concentric circular shapes of the sample pattern and of the circles of confusion, it may be convenient for the sample regions to also be circular and concentric. For example, the sample regions may be defined as concentric, non-overlapping rings that completely tile the pattern area. There may be as many rings as there are samples in the pattern, and the rings may be defined such that all have the same area, with the sum of their areas matching the area of the sample pattern. The rings may each be scaled by the Pattern Radius, such that their tiling relationship to the pattern area is maintained as the pattern is scaled.

In at least one embodiment, the assignment of the rings to the samples may performed in a manner than assures that each sample is within the area of its assigned ring, or is at least close to its assigned ring. One such assignment sorts the sample locations by their distance from the center of the pattern, sorts the rings by their distance from the center, and then associates each sample location with the corresponding ring. Other assignment algorithms are possible. These sortings and assignments may be done as part of the Player Pre-Processing, so they are not a computational burden during execution of player rendering loop 200. The inner and outer radii of each ring may be stored in a table, or may be computed when required.

One additional advantage of rings as sample regions is that rotating the sample pattern has no effect on the shapes or positions of the sample regions, because they are circularly symmetric. Yet another advantage is the resulting simplicity of computing the area of intersection of a ring and a circle of confusion, when both have the same center. A potential disadvantage is that a sample's region is not generally symmetric about its location, as the square regions were about pixel centers.

In at least one embodiment, using a scaled, circular stochastic sample pattern with ring-shaped sample regions, the CoC radius Cₛ is computed separately for each sample (not sample pixel), based on its lambda depth L.

Cₛ=B|F−Lₛ|

The weight of each sample is the area of the intersection of its ring-shaped region with the CoC of the center pixel (with radius Cₛ), divided by the area of the CoC of the center pixel (with radius Cₛ). Summation of samples then proceeds as described above in the Buckets and Occlusion sections.

Variations of the ring geometry are possible. For example, in at least one embodiment, a smaller number of rings, each with greater area, may be defined, and multiple samples may be associated with each ring. The weight of each sample is then computed as the area of the intersection of its ring-shaped region with the CoC of the center pixel (with radius Cₛ), divided by the product of the number of samples associated with the ring with the area of the CoC of the center pixel (with radius Cₛ). Other variations are possible.

### 8) Pattern Exponent

In at least one embodiment, the scaling of the sample pattern may be modified such that it is nonlinear, concentrating samples toward the center of the circular sample pattern. The sample rings may also be scaled non-linearly, such that the areas of inner rings are less than the average ring area, and the areas of outer rings are greater. Alternatively, the rings may be scaled linearly, such that all have the same area.

Nonlinear scaling may be directed by the Pattern Exponent, as described above in connection with spatial analysis stage 217.

### 9) Special Treatment of the Center Sample

In at least one embodiment, a center sample may be taken at the center of the center pixel. This sample location may be treated as the innermost sample in the sample pattern, whose sample region is therefore a disk instead of a ring. The weight computed for the center sample may be constrained to be equal to one even if the Cₛ is zero (that is, if the center pixel is in perfect focus). Furthermore, the weight of the center sample may be trended toward zero as the Cₛ computed for it increases. With appropriate compensation for the absence of center-sample color contribution, this trending toward zero may reduce artifacts in computed virtual-view bokeh.

### 10) Mid-Bucket Flattening

In at least one embodiment, an additional mid-bucket weight may be maintained, which accumulates weights computed as though the sample lambda depth were equal to the center-pixel lambda depth, rather than simply near to this depth. As the flattened mid-bucket weight approaches one, the actual mid-bucket weight may be adjusted so that it too approaches one. This compensation may reduce artifacts in the computed virtual view.

### Noise Reduction 223

In at least one embodiment, a noise reduction stage 223 is performed, so as to reduce noise that may have been introduced by stochastic sampling in stochastic blur stage 221. Any known noise-reduction algorithm may be employed. If desired, a simple noise-reduction technique can be used so as not to adversely affect performance, although more sophisticated techniques can also be used.

The sample pattern of a spatial-blurring algorithm may be regular, rather than pseudorandom, but it need not be identical for each pixel in the blur view. In at least one embodiment, the pattern may be varied based on additional information. For example, it may be observed that some areas in the incoming blur view exhibit more noise artifacts than others, and that these areas are correlated to spatial information, such as the outputs of spatial analysis stage 217 (e.g., Pattern Radius, Pattern Exponent, and Bucket Spread). Functions of these outputs may then be used to parameterize the spatial-blur algorithm, so that it blurs more (or differently) in image regions exhibiting more noise, and less in image regions exhibiting less noise. For example, the Pattern Exponent may be used to scale the locations of the samples in the spatial-blur algorithm, as a function of a fixed factor, causing image regions with greater pattern exponents to be blurred more aggressively (by the larger sample pattern) than those with pattern exponents nearer to one. Other parameterizations are possible, using existing or newly developed spatial-analysis values.

For efficiency of operation, it may be found that blurring two or more times using a spatial-blur algorithm with a smaller number of sample locations may yield better noise reduction (for a given computational cost) than blurring once using a spatial-blur algorithm that uses a larger number of samples. The parameterization of the two or more blur applications may be identical, or may differ between applications.

In at least one embodiment, in addition to color, the blur-view output of stochastic blur stage 221 may include a per-pixel Stitch Factor that indicates to stitched interpolation stage 224 what proportion of each final pixel's color should be sourced from the sharp, full-resolution mesh view (from merge and layer stage 209). Noise reduction may or may not be applied to the Stitch-Factor pixel values. The Stitch Factor may also be used to parameterize the spatial-blur algorithm. For example, the spatial-blur algorithm may ignore or devalue samples as a function of their Stitch Factors. More specifically, samples whose stitch values imply almost complete replacement by the sharp, full-resolution color at stitched interpolation stage 224 may be devalued. Other functions of pixel Stitch Factors and of the Spatial-Analysis values may be employed.

### Stitched Interpolation 224

Stitched interpolation stage 224 combines the blurred, possibly decimated blur view 222 (from stochastic blur stage 221 and noise reduction stage 223), with the sharp, full-resolution mesh view 226 (from merge and layer stage 209), allowing in-focus regions of the final virtual view to have the best available resolution and sharpness, while out-of-focus regions are correctly blurred. Any of a number of well-known algorithms for this per-pixel combination may be used, to generate a full resolution virtual view 225. If the blur view 222 received from noise reduction stage 223 is decimated, it may be up-sampled at the higher rate of the sharp, full-resolution mesh view. This up-sampling may be performed using any known algorithm. For example, the up-sampling may be a bilinear interpolation of the four nearest pixel values.

In at least one embodiment, stochastic blur stage 221 may compute the fraction of each pixel's color that should be replaced by corresponding pixel(s) in the sharp, full-resolution virtual view 225, and output this per-pixel value as a stitch factor. Stochastic blur stage 221 may omit the contribution of the in-focus mesh view from its output pixel colors, or it may include this color contribution.

In at least one embodiment, stitched interpolation stage 224 may use the stitch factor to interpolate between the pixel in (possibly up-sampled) blur view 222 and sharp-mesh-view pixel from mesh view 226, or it may use the stitch factor to effectively exchange sharp, decimated color in the (possibly up-sampled) blur-view 222 pixels for sharp, full-resolution color. One approach is to scale the sharp, decimated pixel color by the stitch factor and subtract this from the blurred pixel color; then scale the sharp, full-resolution pixel color by the stitch factor and add this back to the blurred pixel color. Other algorithms are possible, including algorithms that are parameterized by available information, such as existing or newly developed spatial-analysis values.

Once player rendering loop 200 has completed, the resulting output (such as full-resolution virtual view 225) can be displayed on display screen 716 or on some other suitable output device.

### Variations

One skilled in the art will recognize that many variations are possible. For example:
In at least one embodiment, the center view may actually also be a hull view, meaning that it may not necessarily have the symmetry requirement described in the glossary.
Scene surfaces that are occluded in the center view, but are visible in virtual views with non-zero relative centers of perspective, may be represented with data structures other than hull images. For example, a second center view can be provided, whose pixel colors and depths were defined not by the nearest surface to the camera, but instead by the next surface. Alternatively, such a second center view and a center view whose pixel colors and depths were defined by the nearest surface can be combined into a Layered Depth Image. All view representations can be generalized to Layered Depth Images.
In some cases, algorithms may be moved from player rendering loop 200 to Player Pre-Processing, or vice versa, to effect changes in the tradeoff of correctness and performance. In some embodiments, some stages may be omitted (such as, for example, occlusion filling).
In addition, algorithms that are described herein as being shaders are thus described only for convenience. They may be implemented on any computing system using any language.

The above description and referenced drawings set forth particular details with respect to possible embodiments. Those of skill in the art will appreciate that the techniques described herein may be practiced in other embodiments. First, the particular naming of the components, capitalization of terms, the attributes, data structures, or any other programming or structural aspect is not mandatory or significant, and the mechanisms that implement the techniques described herein may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some embodiments may include a system or a method for performing the above-described techniques, either singly or in any combination. Other embodiments may include a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions of described herein can be embodied in software, firmware and/or hardware, and when embodied in software, can be downloaded to reside on and be operated from different platforms used by a variety of operating systems.

Some embodiments relate to an apparatus for performing the operations described herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CDROMs, magnetic-optical disks, read-only memories (ROMs), random access memories (RAMs), EPROMs, EEPROMs, flash memory, solid state drives, magnetic or optical cards, application specific integrated circuits (ASICs), and/or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the techniques set forth herein are not described with reference to any particular programming language. It will be appreciated that a variety of programming languages may be used to implement the techniques described herein, and any references above to specific languages are provided for illustrative purposes only.

Accordingly, in various embodiments, the techniques described herein can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the techniques described herein include: a mobile phone, personal digital assistant, smartphone, kiosk, server computer, enterprise computing device, desktop computer, laptop computer, tablet computer, consumer electronic device, television, set-top box, or the like. An electronic device for implementing the techniques described herein may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

In various embodiments, the techniques described herein can be implemented in a distributed processing environment, networked computing environment, or web-based computing environment. Elements can be implemented on client computing devices, servers, routers, and/or other network or non-network components. In some embodiments, the techniques described herein are implemented using a client/server architecture, wherein some components are implemented on one or more client computing devices and other components are implemented on one or more servers. In one embodiment, in the course of implementing the techniques of the present disclosure, client(s) request content from server(s), and server(s) return content in response to the requests. A browser may be installed at the client computing device for enabling such requests and responses, and for providing a user interface by which the user can initiate and control such interactions and view the presented content.

Any or all of the network components for implementing the described technology may, in some embodiments, be communicatively coupled with one another using any suitable electronic network, whether wired or wireless or any combination thereof, and using any suitable protocols for enabling such communication. One example of such a network is the Internet, although the techniques described herein can be implemented using other networks as well.

While a limited number of embodiments has been described herein, those skilled in the art, having benefit of the above description, will appreciate that other embodiments may be devised which do not depart from the scope of the claims. In addition, it should be noted that the language used in the specification has been principally selected for readability and instructional purposes, and may not have been selected to delineate or circumscribe the inventive subject matter. Accordingly, the disclosure is intended to be illustrative, but not limiting.

What is claimed is:

1. A computer-implemented method for generating compressed representations of light-field picture data, comprising:
receiving light-field picture data;
at a processor, determining a plurality of vertex coordinates from the compressed light-field picture data;
at the processor, generating output coordinates based on the determined plurality of vertex coordinates;
at the processor, rasterizing the output coordinates to generate fragments;
at the processor, applying texture data to the fragments, to generate a compressed representation of the light-field picture data; and
storing the compressed representation of the light-field picture data in a storage device.

2. The computer-implemented method of claim 1, wherein the storage device comprises a frame buffer.

3. The computer-implemented method of claim 1, wherein the compressed representation of the light-field picture data comprises colors and depth values.

4. The computer-implemented method of claim 1, wherein the compressed representation of the light-field picture data comprises at least one extended depth-of-field view and depth information.

5. The computer-implemented method of claim 1, wherein rasterizing the output coordinates to generate fragments comprises performing interpolation to generate interpolated pixel values.

6. The computer-implemented method of claim 1, wherein applying texture data to the fragments comprises performing at least one selected from the group consisting of replacement, blending, and depth-buffering.

7. A computer-implemented method for projecting at least one virtual view from compressed light-field picture data, comprising:
receiving compressed light-field picture data;
at a processor, generating a plurality of warped mesh views from the received compressed light-field picture data;
at the processor, merging the generated warped mesh views;
at the processor, generating at least one virtual view from the merged mesh views; and
outputting the generated at least one virtual view at an output device.

8. The computer-implemented method of claim 7, wherein receiving compressed light-field picture data comprises receiving, for each of a plurality of pixels, at least one selected from the group consisting of a depth mesh, a blurred center view, and a plurality of hull mesh views.

9. The computer-implemented method of claim 7, wherein generating a plurality of warped mesh views from the received compressed light-field picture data comprises, for each of a plurality of pixels:
receiving a desired relative center of projection;
applying a warp function to the depth mesh, blurred center view, hull mesh views, and desired center of projection to a warped mesh view.

10. The computer-implemented method of claim 9, further comprising, for each of a plurality of pixels, performing at least one image operation on the warped mesh view.

11. The computer-implemented method of claim 7, further comprising, after merging the generated warped mesh views and prior to generating at least one virtual view from the merged mesh views:
at the processor, decimating the merged mesh views.

12. The computer-implemented method of claim 11, further comprising, after decimating the merged mesh views and prior to generating at least one virtual view from the merged mesh views:
reducing the decimated merged mesh views.

13. The computer-implemented method of claim 12, further comprising, after reducing the decimated merged mesh views and prior to generating at least one virtual view from the merged mesh views:
performing spatial analysis to generate at least one selected from the group consisting of: pattern radius; pattern exponent, and bucket spread.

14. The computer-implemented method of claim 12, further comprising, after performing spatial analysis and prior to generating at least one virtual view from the merged mesh views, performing at least one selected from the group consisting of:
at the processor, applying a stochastic blur function to determining a blur view;
at the processor, applying a noise reduction function; and
at the processor, performing stitched interpolation on the determined blur view.

15. The computer-implemented method of claim 7, wherein at least the genera ting and merging steps are performed at an image capture device.

16. The computer-implemented method of claim 7, wherein at least the generating and merging steps are performed at a device separate from an image capture device.

17. A non-transitory computer-readable medium for generating compressed representations of light-field picture data, comprising instructions stored thereon, that when executed by a processor, perform the steps of:
receiving light-field picture data;
determining a plurality of vertex coordinates from the compressed light-field picture data;
generating output coordinates based on the determined plurality of vertex coordinates;
rasterizing the output coordinates to generate fragments;
applying texture data to the fragments, to generate a compressed representation of the light-field picture data; and
causing a storage device to store the compressed representation of the light-field picture data.

18. The non-transitory computer-readable medium of claim 17, wherein causing a storage device to store the compressed representation comprises causing a frame buffer to store the compressed representation.

19. The non-transitory computer-readable medium of claim 17, wherein the compressed representation of the light-field picture data comprises colors and depth values.

20. The non-transitory computer-readable medium of claim 17, wherein the compressed representation of the light-field picture data comprises at least one extended depth-of-field view and depth information.

21. The non-transitory computer-readable medium of claim 17, wherein rasterizing the output coordinates to generate fragments comprises performing interpolation to generate interpolated pixel values.

22. The non-transitory computer-readable medium of claim 17, wherein applying texture data to the fragments comprises performing at least one selected from the group consisting of replacement, blending, and depth-buffering.

23. A non-transitory computer-readable medium for projecting at least one virtual view from compressed light-field picture data, comprising instructions stored thereon, that when executed by a processor, perform the steps of:
receiving compressed light-field picture data;
generating a plurality of warped mesh views from the received compressed light-field picture data;
merging the generated warped mesh views;
generating at least one virtual view from the merged mesh views; and
causing an output device to output the generated at least one virtual view.

24. The non-transitory computer-readable medium of claim 23, wherein receiving compressed light-field picture data comprises receiving, for each of a plurality of pixels, at least one selected from the group consisting of a depth mesh, a blurred center view, and a plurality of hull mesh views.

25. The non-transitory computer-readable medium of claim 23, wherein genera ting a plurality of warped mesh views from the received compressed light-field picture data comprises, for each of a plurality of pixels:
receiving a desired relative center of projection;
applying a warp function to the depth mesh, blurred center view, hull mesh views, and desired center of projection to a warped mesh view.

26. The non-transitory computer-readable medium of claim 25, further comprising instructions that, when executed by a processor, perform, for each of a plurality of pixels, at least one image operation on the warped mesh view.

27. The non-transitory computer-readable medium of claim 23, further comprising instructions that, when executed by a processor, after merging the generated warped mesh views and prior to generating at least one virtual view from the merged mesh views, decimate the merged mesh views.

28. The non-transitory computer-readable medium of claim 17, further comprising instructions that, when executed by a processor, after decimating the merged mesh views and prior to generating at least one virtual view from the merged mesh views, reduce the decimated merged mesh views.

29. The non-transitory computer-readable medium of claim 28, further comprising instructions that, when executed by a processor, after reducing the decimated merged mesh views and prior to generating at least one virtual view from the merged mesh views:
perform spatial analysis to generate at least one selected from the group consisting of: pattern radius; pattern exponent, and bucket spread.

30. The non-transitory computer-readable medium of claim 28, further comprising instructions that, when executed by a processor, after performing spatial analysis and prior to generating at least one virtual view from the merged mesh views, perform at least one selected from the group consisting of:
applying a stochastic blur function to determining a blur view;
applying a noise reduction function; and
performing stitched interpolation on the determined blur view.

31. A system for generating compressed representations of light-field picture data, comprising:
a processor, configured to:
receive light-field picture data;
determine a plurality of vertex coordinates from the compressed light-field picture data;
generate output coordinates based on the determined plurality of vertex coordinates;
rasterize the output coordinates to generate fragments; and
apply texture data to the fragments, to generate a compressed representation of the light-field picture data; and
a storage device, communicatively coupled to the processor, configured to store the compressed representation of the light-field picture data.

32. The system of claim 31, wherein the storage device comprises a frame buffer.

33. The system of claim 31, wherein the compressed representation of the light-field picture data comprises colors and depth values.

34. The system of claim 31, wherein the compressed representation of the light-field picture data comprises at least one extended depth-of-field view and depth information.

35. The system of claim 31, wherein rasterizing the output coordinates to generate fragments comprises performing interpolation to generate interpolated pixel values.

36. The system of claim 31, wherein applying texture data to the fragments comprises performing at least one selected from the group consisting of replacement, blending, and depth-buffering.

37. A system for projecting at least one virtual view from compressed light-field picture data, comprising:
a processor, configured to:
receive compressed light-field picture data;
generate a plurality of warped mesh views from the received compressed light-field picture data;
merge the generated warped mesh views; and
generate at least one virtual view from the merged mesh views; and
an output device, communicatively coupled to the processor, configured to output the generated at least one virtual view.

38. The system of claim 37, wherein receiving compressed light-field picture data comprises receiving, for each of a plurality of pixels, at least one selected from the group consisting of a depth mesh, a blurred center view, and a plurality of hull mesh views.

39. The system of claim 37, wherein generating a plurality of warped mesh views from the received compressed light-field picture data comprises, for each of a plurality of pixels:
receiving a desired relative center of projection;
applying a warp function to the depth mesh, blurred center view, hull mesh views, and desired center of projection to a warped mesh view.

40. The system of claim 39, further comprising, for each of a plurality of pixels, performing at least one image operation on the warped mesh view.

41. The system of claim 37, wherein the processor is further configured to, after merging the generated warped mesh views and prior to generating at least one virtual view from the merged mesh views:
decimate the merged mesh views.

42. The system of claim 41, wherein the processor is further configured to, after decimating the merged mesh views and prior to generating at least one virtual view from the merged mesh views:
reduce the decimated merged mesh views.

43. The system of claim 42, wherein the processor is further configured to, after reducing the decimated merged mesh views and prior to generating at least one virtual view from the merged mesh views:
perform spatial analysis to generate at least one selected from the group consisting of: pattern radius; pattern exponent, and bucket spread.

44. The system of claim 42, wherein the processor is further configured to, after performing spatial analysis and prior to generating at least one virtual view from the merged mesh views, perform at least one selected from the group consisting of:
applying a stochastic blur function to determining a blur view;
applying a noise reduction function; and
performing stitched interpolation on the determined blur view.

45. The system of claim 37, wherein the processor is a component of an image capture device.

46. The system of claim 37, wherein the processor is a component of a device separate from an image capture device.
